(19) United States
(12) Patent Application Publication
(10) Pub. No.: US 2018/0060771 A1
(43) Pub. Date: Mar. 1, 2018

(54) SYSTEMS AND METHODS FOR CREATING VOLUME/MARKET WEIGHTED AVERAGE PRICE BENCHMARK INDICES FOR FRESH FOODS

(71) Applicant: AXI System, Inc., Brooklyn, NY (US)

(72) Inventor: Maxence G. Mangin, New York, NY (US)

(73) Assignee: AXI System, Inc., BROOKLYN, NY (US)

(21) Appl. No.: 15/668,280

(22) Filed: Aug. 3, 2017

Related U.S. Application Data
(60) Provisional application No. 62/379,433, filed on Aug. 25, 2016.

(51) Int. Cl. G06Q 10/06; G06Q 10/04; G06F 17/30; G06F 17/18

(52) U.S. Cl. CPC G06Q 10/0631; G06F 17/18; G06F 17/30241; G06Q 10/04

(57) ABSTRACT

Systems and methods for creating volume/market weighted average price benchmark indexes for perishable agricultural products. At least one user device constructed and configured in network-based communication with an analytics platform. The analytics platform collects, analyzes, validates and normalizes data elements for the perishable agricultural products in real time, thereby generating processed data. The analytics platform calculates a benchmark price for a perishable agricultural product weighted by traded volumes based on the processed data and location data. The at least one user device is operable to receive and display the benchmark price.

### CROSS-REFERENCES TO RELATED APPLICATIONS

This application relates to and claims priority from the following U.S. Patent Applications. This application claims priority from U.S. Provisional Patent Application No. 62/379,433 filed Aug. 25, 2016, which is incorporated herein by reference in its entirety.

### BACKGROUND OF THE INVENTION

### 1. Field of the Invention

The present invention relates to systems and methods for pricing, sales and purchases optimization of perishable agricultural products, specialty crop and meat products, as well as farm investments, crop insurance valuations and operating loans.

### 2. Description of the Prior Art

There are extensive mechanisms for various commodities, such as crops, energy, and metals. For example, commodity crops (grains, sugar, cotton) have futures exchanges that provide benchmark prices. However, this is not the case for perishable foods. Perishable foods cannot be traded on such an exchange because of perishability, lack of storability, unique volumes, etc. There is no single market, each is incredibly fragmented and opaque. There is nothing close to a benchmark index or commonly used metrics for fresh perishable foods.

By way of example the following are relevant prior art documents relating to commodity pricing and indexing:

U.S. Pat. No. 8,271,374 for “Method for Assessing a Commodity Price and Assessment Determined Thereby” by inventor Jorge Eduardo Montepeque, filed Jul. 29, 2002, describes a method of assessing a market price of a benchmark grade of a commodity. The method includes artificially injecting additional volumes of the benchmark grade into the marketplace to thereby increase the market activity upon which the assessment is based. By increasing the market activity upon which the benchmark assessment is based, problems associated with having a small number of market events for assessing the benchmark price, such as price volatility, may be avoided. Additional volumes of the benchmark grade may be artificially injected into the marketplace by including, in the assessment of the benchmark price, observations of market events involving one or more alternative, non-benchmark grades of the commodity. Alternatively, or in addition, additional volumes of the benchmark grade may be artificially injected into the marketplace by permitting a seller offering cargoes of the benchmark grade of the commodity to actually deliver a cargo of one or more alternative, non-benchmark grades of the commodity in satisfaction of a contract for sale of the benchmark grade.

U.S. Pat. No. 7,593,878 for “Method of constructing an investment portfolio and computing an index thereof” by inventor David M. Blitzer et al., filed May 18, 2006, describes a method for selecting investment assets for a portfolio. The method is based upon a score derived for each asset which is indicative of its style, for example, whether a stock is predominantly a growth or a value stock. Different sets of score factors are designated for assessing an asset's score with respect to a first characteristic, or style, indicated by one set of score factors and with respect to a second characteristic, or style, indicated by the second set of factors. Based on the asset's score from one set of score factors relative to its score from a second set of score factors, the asset's predominant character can be determined. Also, an index for a number of assets can be computed in which each constituent asset's weight is determined by the asset's score with respect to one style or another.

U.S. Pat. No. 8,688,516 for “Methods and apparatus for integrating volumetric sales data, media consumption information, and geographic-demographic data to target advertisements” by inventor Jerome Shimizu et al., filed Mar. 14, 2011, describes a method generating a geographic-based consumption index for a product based on a first per-person sales volume of the product in a first cell of a plurality of geographic cells of a larger geographic area. The example method also involves generating a demographic-based consumption index for the product based on a second per-person sales volume of the product for a demographic group in the first cell. An advertisement to present to a person is selected based on an online web interest, a geographic location, and a demographic of the person and further based on the geographic-based consumption index and the demographic-based consumption index.

U.S. Publication No. 2013/0332205 for “SYSTEM AND METHOD FOR ESTABLISHING AN INSURANCE POLICY BASED ON VARIOUS FARMING RISKS” by inventor David Friedberg et al., filed Mar. 15, 2013, describes a system and method for generating an insurance policy to protect a crop against weather-related perils. A customized insurance policy is generated based on crop type data and location data. The customized insurance policy is generated utilizing a weather-impact model for the type of crop and the geographic area.

U.S. Publication No. 2008/0177675 for “Commodity-Based Index and Investment and Financial Risk Management Products” by inventor Jonathan Arginteanu, filed Dec. 12, 2007, describes investment and financial risk management products and methods based on a commodity index. The commodity index has a numerical value that, based on an algorithm, tracks the settlement prices of a predetermined group of commodities on a futures exchange. Based on this index, a futures contract is offered on the futures exchange. Moreover, an exchange-traded fund, options on the exchange-traded fund, and options on the futures contract are also provided.

U.S. Publication No. 2009/0132432 for “COMMODITY, PRICE AND VOLUME DATA SHARING SYSTEM FOR NON-PUBLICLY TRADED COMMODITIES” by inventor Rock L. Clapper, filed Sep. 30, 2008, describes a system and a method for gathering non-publicly available commodity data, processing the data, and distributing the processed information over the Internet or similar backbone in a delayed or real time manner. In particular, such a system provides technology and a process that gathers data from multiple operating systems and diverse software systems, receives the data in a central processing system, creates weighted averages, tickers, historical charts, and tables, and allows access to such from web-enabled devices.

U.S. Publication No. 2012/0054085 for “Methods and Systems for Providing a Beta Commodity Index” by inventor Tarik Riviere, filed Sep. 29, 2011, describes methods and systems for providing a beta commodity index. In at least one aspect, the invention comprises a computer-implemented method comprising: electronically receiving data regarding prices of exchange-traded futures contracts on physical commodities; selecting, based on said received data, one or more of said futures contracts to be referenced by a commodity index; identifying, on a periodic basis, one or more deferred futures contracts into which said selected one or more futures contracts will roll; and providing one or more derivative products linked to said commodity index. In at least one aspect, the invention comprises a commodity index that references exchange-traded futures contracts on physical commodities, wherein one or more deferred futures contracts into which the futures contracts will roll are identified on a periodic basis, and wherein said one or more deferred futures contracts are identified based on an effective spot price. In at least one aspect, the invention comprises a derivative product linked to a commodity index.

U.S. Publication No. 2013/0036071 for “DYNAMIC COMMODITY INDEX METHODOLOGY” by inventor K Geert Rouwenhorst, filed Jul. 27, 2012, describes A rules-based commodity index methodology. The rules-based commodity index methodology is based on the performance of a fully margined or collateralized portfolio of 14 futures contracts with equal weights from six commodity sectors: energy, precious metals, industrial metals, grains, softs and livestock.

U.S. Publication No. 2015/0073972 for “SYSTEMS AND METHODS FOR TRADES PRICED RELATIVE TO A REFERENCE BENCHMARK VALUE ASSOCIATED WITH AN UNDERLYING INDEX FUTURE” by inventor Clifford J. Weber, filed Nov. 17, 2014, describes systems and methods for trades priced relative to a reference benchmark value associated with an underlying index future. According to some embodiments, an indication of a trade priced relative to a reference benchmark value (e.g., a trade at index close transaction) associated with an underlying index future may be received when a basis of the trade is agreed to by parties of the trade. Moreover, the indication may be received at least one day prior to a determination of a final price and quantity of the trade. The trade might create, according to some embodiments, any derivative, such as a future, an option, or a combination of put and call options. The trade may be reported and cleared, and it may then be arranged for the trade to physically settle into the underlying index future.

U.S. Publication No. 2015/0213457 for “SYSTEM AND METHODS FOR PRICING A COMMODITY” by inventor Jason Libersky, filed Jan. 27, 2014, describes a method for differentiating a commodity. The method comprises establishing a predetermined set of protocols; establishing a standard for each protocol; collecting data from at least one user device; determining by one or more computing devices whether information regarding each of the protocols meets or exceeds an identified protocol compliance threshold; and identifying the commodity as a differentiated commodity when at least the plurality of the protocols meets or exceeds the identified protocol compliance threshold. The at least one user device is configured to send information regarding the protocols.

None of the prior art describes a benchmark price for perishable food as specified in the present invention.

### SUMMARY OF THE INVENTION

The present invention proposes systems and methods for generating a benchmark perishable food wholesale price for use in business, accounting and forecasting. A customized perishable food benchmark price is created based on customized product data, location data and a method of assessing the marketplace benchmark price. Unique customized perishable food wholesale prices provided by the present invention can be used in building a custom portfolio, basket, or menu. Preferably, an average aggregate pricing per pound is used as a benchmark price in the present invention. The systems and methods provided by the present invention also generate volume/market weighted average price benchmark indices for fresh foods, which are used to inform or be interpreted for stock trading, menu planning, and harvest planning.

The technology platform in the present invention is operable to aggregate raw daily, weekly, monthly data from USDA's AMS reports and various USDA-verified state-level agricultural reports. The USDA collects information on the production, import, shipment & prices of 492 specialty crops. These are packaged and sold in 42 established units of measurement (typically by volume) resulting in hundreds of individually assignable weights.

The technology platform is further operable to standardize different metrics into a uniform format, preferably, dollar per pound ($/lb). The technology platform is further operable to provide analytics of the aggregated and standardized data, for example, statistics, and technical analysis. The technology platform is further operable to redisplay the processed data in charts, tables and graphs on a purpose-built web application. The technology platform is further operable to bundle the processed data as new instruments for forecasting and business planning.

In one embodiment, the present invention is directed to systems and methods for creating volume/market weighted average price benchmark indexes for perishable agricultural products. At least one user device constructed and configured in network-based communication with an analytics platform. The analytics platform collects, analyzes, validates and normalizes data elements for the perishable agricultural products from data sources in real time, thereby generating processed data. The analytics platform calculates a benchmark price for a perishable agricultural product weighted by traded volumes based on the processed data and location data. The at least one user device is operable to receive and display the benchmark price. Preferably, the benchmark price is in a normalized form of dollar per pound.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is an overview of a process in the present invention.

FIG. 2 provides quick facts of the three main sectors included AGCHEQ Data Universe.

FIG. 3 is an overview of the wholesale markets according to one embodiment of the present invention.

FIG. 4 is an overview of the meat sector in the AGCHEQ Data Universe.

FIG. 5 is an overview of the fruit sector in the AGCHEQ Data Universe.

FIG. 6 is an overview of the vegetable sector in the AGCHEQ Data Universe.

FIG. 7 is a data example for AGCHEQ Tropical Data Universe.

FIGS. 8-9 are product data overview in the AGCHEQ Tropical Data Universe.

FIG. 10 provides quick facts of the AGCHEQ Index Universe.

FIG. 11 is a sector overview of the AGCHEQ Index Universe.

FIGS. 12-14 provide an overview of company cost index of the AGCHEQ Index Universe.

FIG. 15 is an illustration of USDA product price fields parsing from a USDA price listing.

FIG. 16 is an example of USDA price quote.

FIG. 17 is an illustration of creating Default Aggregate Products in one embodiment of the present invention.

FIG. 18 is an illustration of creating Market or Region Specific Aggregate Products in one embodiment of the present invention.

FIG. 19 is an illustration of creating Custom Aggregate Products in one embodiment of the present invention.

FIG. 20 is an illustration of creating a stock index and a user index in one embodiment of the present invention.

FIG. 21 is an illustration of creating a portfolio in one embodiment of the present invention.

FIG. 22 is an illustration of quoting a Real Price for a Real Product in one embodiment of the present invention.

FIG. 23 is an illustration of quoting an Aggregate Price for an Aggregate Product in one embodiment of the present invention.

FIG. 24 is a flow chart showing a derived metric computation. USDA price line items are used to generate Real Products, which are used to create Aggregate Products, both of which are used to create indices, which are combined to create portfolios.

FIG. 25 is a flow chart showing Real Product and Real Price harvesting.

FIG. 26 is a flow chart showing Aggregate Price calculation phase.

FIG. 27 is an illustration of a process over the technology platform in one embodiment of the present invention.

FIG. 28 is a flow chart for creating a new index.

FIG. 29 is an example of creating an index composed of a portfolio of Boston-specific prices including certain Real Products.

FIG. 30 is an example set of real and aggregate products.

FIG. 31 is a screenshot for platform login over a web application.

FIG. 32 is an interface for fruit and vegetable analysis.

FIG. 33 is an interface for beef analysis.

FIG. 34 is USDA product data and platform metadata for the brisket analysis nationally.

FIG. 35 is a screenshot of a portfolio of a leading New York City (NYC) restaurant group.

FIG. 36 is a screenshot of creating a new portfolio.

FIG. 37 is a screenshot of a user's portfolio.

FIG. 38 is a screenshot of modifying portfolio contents.

FIG. 39 is a screenshot of the description about iceberg lettuce in New York Market in a user's portfolio.

FIG. 40 is a screenshot of historical data about iceberg lettuce in New York market in a user's portfolio.

FIG. 41 is a screenshot of a product chart and analysis.

FIG. 42 is a screenshot of entitlements in a portfolio.

FIG. 43 is a screenshot of managing entitlements for a unique product in a portfolio.

FIG. 44 is a table representing company-operated restaurant margin components as a percent of sales.

FIG. 45 is a AGCHEQ Ground Beef 80-85% Index's chart since Jan. 1, 2015.

FIG. 46 is a MCD stock chart for the same time period (courtesy of Yahoo Finance).

FIG. 47 is a comparison of ground beef 80-85% index and MCD stock over time.

FIG. 48 shows a linear regression of MCD stock performance and AGCHEQ Ground Beef 80-85% Index.

FIG. 49 is a comparison of AGCHEQ Tomato New York Index and AGCHEQ Tomato Los Angeles Index.

FIG. 50 is a comparison of AGCHEQ Romaine Lettuce New York Index and AGCHEQ Romaine Lettuce Los Angeles Index.

### DETAILED DESCRIPTION

In the United States, there are around 245,000 fruit and vegetable farms. These farmers receive an average of 9.5 cents on the dollar for fruit and vegetables destined for processing, whereas for fresh vegetables 35.5 cents, and for fresh fruit 35.7 cents. Meanwhile, there are more than 1 million food service operations including restaurants, restaurant chains, fast food, and cafeterias; nearly 38,000 supermarkets and 153,000 convenience stores, about 60,000 food pantries and 2,000 food banks; more than 8,400 farmers' markets; 13 domestic terminal markets which are U.S. Department of Agriculture (USDA) designated in major cities; and 14 international terminal markets which are U.S. Department of Agriculture (USDA) designated in major cities; and dozens of USDA shipping points.

In agriculture, when it comes to the commodity crops such as corn, wheat, soy, there are extensive market mechanisms that deliver price discovery, market transparency, efficient negotiations and risk management. For example, commodity crops (grains, sugar, cotton) have centralized, electronic futures exchanges that provide benchmark prices. However, there are no such price benchmark mechanisms available to perishable foods, especially specialty crop agriculture.

Section 101 of the Specialty Crops Competitiveness Act of 2004 (7 U.S.C. 1621 note) and amended under Section 10010 of the Agricultural Act of 2014, Public Law 113-79 (the Farm Bill) defines specialty crops as “fruits and vegetables, tree nuts, dried fruits, horticulture, and nursery crops (including floriculture).” According to the United States Department of Agriculture (USDA), there are 417 Specialty crops that have in total more than 500,000 unique combinations of varieties, packages, grades, size, count, origins, destinations, environment, quality, appearance.

Specialty foods, especially perishable foods cannot be traded on such an exchange because of perishability, lack of storability, unique volumes, etc. There is no single market, each is incredibly fragmented and opaque. There is nothing close to a benchmark price index or commonly used and available metrics.

The Bureau of Labor Statistics (BLS) provides Producer Price Index (PPI) changes for select commodities but not underlying prices. Financial participants rely on gross indices from the BLS to provide a view into the perishable markets but too general to be applied accurately to any individual case. “Fruit” and “Vegetable” prices are insufficient given market realities. BLS retail Consumer Price Index (CPI) figures are insufficient in correlating to the prices in the wholesale market. The USDA does not provide an accurate holistic product price either, at present only the metadata in a static medium.

Prices fluctuate daily across all markets and are not efficiently correlated because of market opaqueness. The resulting market prices are not disseminated or available in any suitable accessible fashion.

Neither the 245,000 producers (Farmers), nor the more than 1 million Commercial Buyers and Administrators (jointly referred to as “market participants”) have any mechanism for market nor price transparency. While the USDA Agricultural Marketing Service (AMS) collects information about product offerings at various Wholesale Markets across the country, the data issued is ineffective. Instead, participants rely as they always have, on word of mouth and whatever information they can obtain through business contacts or news services, to gain a sense of fair market value.

For participants in the food chain, for example, farmers, distributors, food service and retailers, existing pricing mechanisms depend on at best a typically local, informal network of industry contacts, or more commonly a “cost plus” model that results in persistent inefficiencies and mispricing. In other situations, farmers rely on word of mouth (of rivals) and the word of their counter parties (i.e. business opponents). Food buyers rely on the word of their wholesalers (business opponents). As a result, the industry is notoriously plagued by price abuses on both ends, from the farm gate to the institutional kitchen, as the informationally rich and savvy wholesaling middlemen take advantage of the asymmetrical distribution of information. Additionally, at the purchasing end, contracted Food Service Operators have often been discovered to be in criminal collusion with their Wholesale Distributors, passing invoices to their customers for above-market prices while receiving rebates and kickbacks from the distributor after the fact. The lack of accredited price benchmark plagues facility owners such as Schools and Hospitals that have no independent source of price information to verify the charges of their Food Service Operators, currently operating with little transparency or accountability.

When Specialty Crop agriculture has become international, all farmers face competition not just from nearby neighbors but from imported products from across the country and abroad. Local word of mouth has long been insufficient, fraught with bias and inadequacy.

Without a reliable, customized independent benchmark price, it is impossible to optimize sales, marketing, negotiating, budgeting, forecasting, budgeting and execution.

Other government data sources fail to provide customized real time market transparency useful for a Farmer, Commercial Buyer or Administrator. The United States Bureau of Labor Statistics (BLS) provides monthly survey results of the average retail prices for a limited number of products at a regional level. This macro data does not fulfill the needs of market participants. All private alternatives merely republish the government statistics as is, without any processing, in a wholly static and equally insufficient fashion.

Farmers, Food Buyers, Financial participants need to know a real-time and forecastable price for important agricultural commodities. They do not have these prices.

Invention Overview

The present invention is directed to systems and methods for generating a benchmark perishable food wholesale price for use in business, accounting and forecasting. A customized perishable food benchmark price is created based on customized product data, location data and a method of assessing the marketplace benchmark price. Unique customized perishable food wholesale prices provided by the present invention can be used in building a custom portfolio, basket, or menu. Preferably, an average aggregate pricing per pound is used as a benchmark price in the present invention. The systems and methods provided by the present invention also generate volume/market weighted average price benchmark indices for fresh foods, which are used to inform or be interpreted for stock trading, menu planning, and harvest planning.

Excluding government payments, Crop sales represent nearly 100% of a farmer's revenues. Likewise, the costs of food purchases represent more than 30% of food service expenses, and food commodity prices vary more than 100% intra-year. Thus an accurate market insight is the best way to manage risk. The present invention makes wholesale food markets and food costs transparent and offers complete transparency into the meat, poultry, fruit and vegetable markets. The systems and methods in the present invention enable related parties to forecast margins and predict costs with precise technical analysis; anticipate price swings, budget and profit with accurate benchmarks; improve negotiations and keep suppliers honest with daily market updates; and leverage information and save time finding relevant data on-demand.

The present invention is also able to provide insight into the entire food complex with accurate big data, reliable price benchmarks, and precise index solutions. The accurate big data include 20,000+ daily price updates and 20 years of USDA-verified daily market data. The reliable price benchmarks are correlation tested with USDA and BLS record, price data from more than 1000 producers, wholesalers and distribution nationwide. The precise index solutions include tailored index; menu and harvest planners; comprehensive products, markets and cuisines indices.

The present invention also converts data into actionable information and brings tangible changes in business decisions. The present invention provides an accurate system for food distributors and farm partners to decide when and where to purchase specialty products; when and where to sell specialty crops products; how to value farms' production and crop insurance liability/protection; how to offer operating loans, and etc.

The present invention offers both agricultural and food service professionals real-time food market data with proven correlations to company food costs, gross margins and stock prices. The present invention provides insights for agriculture and food service investments, and it is the only source for transparency into the fresh food costs and gross margins of restaurant and hospitality groups, supermarkets and grocery stores, and food distributors and agribusiness. A basis spread between the benchmark price can be created to tie directly back to any individual user's prices paid or received in the market.

The proposed systems and methods utilize a technology platform to systemically collect, normalize, bundle, analyze and redisplay for further use data elements from throughout the food chain for fair price discovery, valuation and forecasting of specialty crops. The present invention provides the unique aggregate Produce indexes by a process that collects, sanitizes, stores and normalizes meta data from the USDA.

The present invention provides systems and methods for viewing, forecasting and assembling market data relating to the agricultural sector. Specific details described in the following sections are illustrative, however, it would be evident to one of ordinary skill in the art that the present invention may be implemented without these specific details.

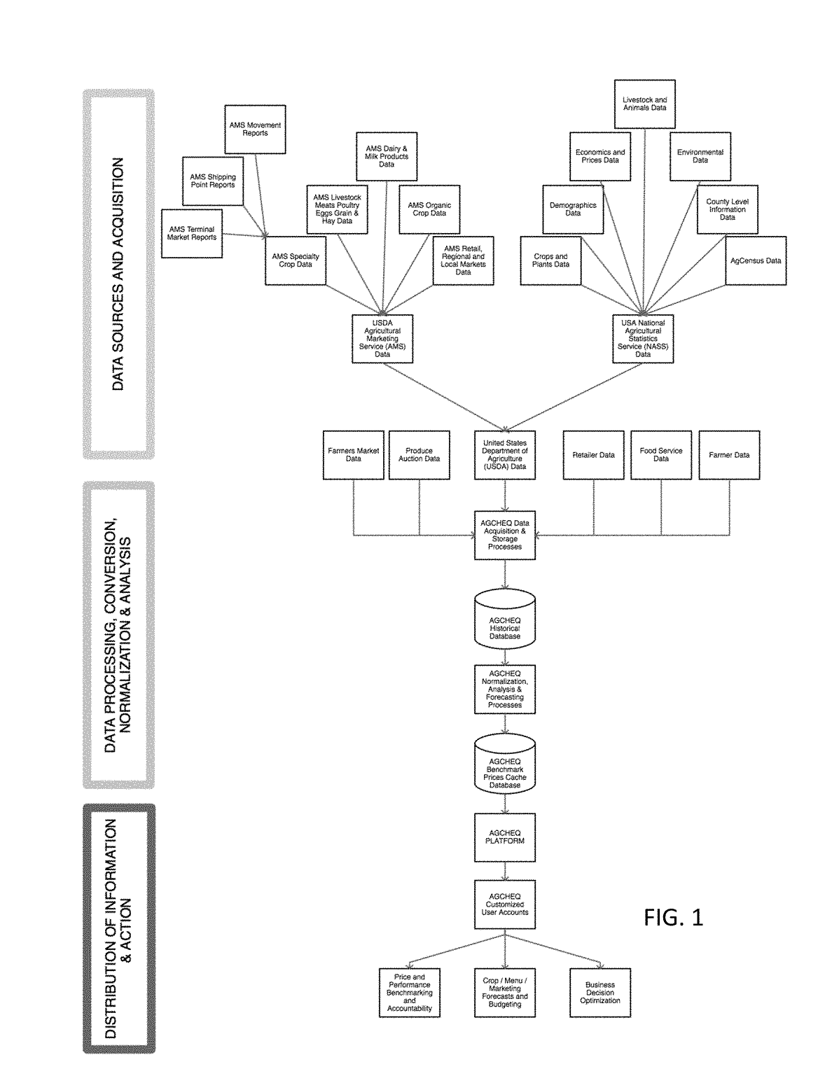

FIG. 1 is an overview of a process in the present invention. At the first stage, data is acquired from various data sources to a proprietary platform. Besides various USDA data, there are farmers market data, produce auction data, retailer data, food service data, and farmer data. At the second stage, the acquired data is processed, converted, normalized and analyzed over the proprietary platform. At the third stage, actionable information is obtained through the second stage and distributed to corresponding parties.

Data Sources and Data Quality

In one embodiment of the present invention, there is a data warehouse and database management platform at the core of the proprietary platform. Data elements collected, stored, normalized and analyzed by the proprietary platform include, for example but not for limitation, Price Reports (e.g. USDA Agricultural Marketing Service (AMS) Terminal Market Reports, Shipping Reports, Retail Reports, Farmers' Market's Price Sheets, Individual Price Sheets, Historical Records), Movement Reports tracking the flow of Produce in/out of US Domestic Markets, Production Reports (e.g. USDA National Agricultural Statistics Service (NASS) Agricultural Census), and Crop Insurance Reports (e.g. USDA Risk Management Agency (RMA) Crop Insurance Price Elections). Data from these various sources are all USDA verified. The present invention does not rely on feedback from industry participants, which are not verified by USDA.

There are 70 primary meat, poultry, fruit and vegetable commodities which are comprised of 387,000+ individual products with 4093 unique packets. There are 199 additional commodities of a tropical, exclusively imported or otherwise infrequent nature. There are 18,000+ daily report updates from 27 international markets, and 265 company menus and indices. Plus, the data warehouse has price databases since 1998.

In one embodiment of the present invention, data from these various sources may be uploaded via an online application, custom-developed process, Application Program Interface (API) or directly from the application's interface. In all cases the data is then processed by a custom normalization application to be stored properly for subsequent analysis and decision-making.

USDA raw data are processed in the proprietary platform as there are various flaws and drawbacks in the USDA raw data. For example, they do not have aggregate meat pricing, they are unable to cross-compare on a single page, there is no benchmark produce pricing, no price per pound for all produce, they need to be filtered, they cannot create a basket, they cannot assign a weighting, they cannot forecast, and it is a gross mistake by simply combining all prices together. Besides, the data quality is important in the present invention. Data from different sources contain errors and typos. For example, cited records of a leading restaurant group are 8.773% corrupted with typos, mistakes and general errors etc. Even the gold-standard benchmark, USDA, has cumulatively thousands of typos and frequently misreported prices due to human errors and lack of proper controls.

Data sources are required to be sanitized through a variety of processes. There are multiple algorithmic filters in the present invention to exclude products known to be of extremely rare and market distortive nature and exclude prices printed more than 4 standard deviations beyond recent market average prices.

As all input data is human sourced, sophisticated new tools are continually being developed for identifying, validating and correcting defective data to continuously refine the historical dataset and meta-analyses in real time to ensure that the data available from the proprietary platform is the more reliable, comparable and actionable food market data available.

Data Collection and Processing

The proprietary platform (AGCHEQ—an acronym of Agricultural Commodity Hedging Exchange Quote) runs a combined daily and historical analysis pipeline on USDA source data, automatically retrieving and parsing raw data files from the USDA Market News endpoints and processing unique price points across thousands of varieties of fruit, vegetable, and protein products.

The proprietary analysis pipeline processes data points through a battery of sophisticated cumulative processes that sanitize, standardize, validate, analyze, and summarize the data, transforming raw feeds into reliable, actionable food market intelligence.

In one embodiment, the proprietary analysis pipeline parallelizes a host of Amazon Web Service (AWS) powered worker nodes that move the data through a variety of specialized high-performance data stores including Amazon's specialized data warehousing service Redshift. Each piece of data that enters the pipeline is uniquely tagged and tracked as it passes through dozens of sanitizing, validating, and analysis sub-processes.

The proprietary platform in the present invention is operable to aggregate raw daily, weekly, monthly data from USDA's AMS reports and various USDA-verified state-level agricultural reports. The USDA collects information on the production, import, shipment & prices of 492 specialty crops. These are packaged and sold in 42 established units of measurement (typically by volume) resulting in hundreds of individually assignable weights.

The proprietary platform is further operable to standardize different metrics (e.g., $, C=, £, ¥, per #, oz, kg, g, carton, case, bushel, basket) into a uniform format, preferably, dollar per pound ($/lb). The proprietary platform is further operable to provide analytics of the aggregated and standardized data, for example, statistics, and technical analysis. The proprietary platform is further operable to redisplay the processed data in charts, tables and graphs on a purpose-built web application. The technology platform is further operable to bundle the processed data as new instruments for forecasting and business planning.

The proprietary platform collects, sanitizes, analyzes, and summarizes real time agricultural market data from a variety of sources according to a proprietary algorithm. The end product of this process is a time series dataset of both the prices of the actual products traded in the agricultural markets as well as proprietary AGCHEQ indexes aggregating these trades, similar to stock market indexes like the S&P 500 but fundamentally unique to every business and user.

AGCHEQ incorporates real time data from a variety of sources, including the USDA. Raw data is automatically retrieved from these third-party entities as soon as it is released. This raw data is then processed through an extensive set of smart filters unique to each data source. In order to produce a reliable, consistent, and comparable data point, the following stages of smart filters are included: Sanitize, Analyze, Validate.

Each data point, depending on the source, may contain inconsistent values. Many data sources are entered by hand by a variety of different agents, and so spelling mistakes, typos, inconsistent capitalization, and other errors are common. The sanitization filters ensure that all values in the data point are normalized.

For most data sources, the analysis stage is comprehensive. In order to produce an end product which is consistent and comparable to products imported from other data sources raw values must be translated into synthesized outputs. For many data sources, this involves intelligently allocating the products, product categories, markets and other descriptive data. For many data sources, the definition of a unique product is arbitrary as a raw data point may describe the price of an item that is defined by 20 different variables. A data point is allocated to a specific product.

Beyond product metadata, price and volume data is normalized, both by translating a multitude of different input units into a standardized format and in many cases through a proprietary product key that enables AGCHEQ to calculate a price per pound where one is not provided. Deriving price per pound is further described under section Deriving a Price Per Pound below.

The final set of smart filters applied to a data point is the validation set. Incoming data may have numerous errors that trigger one of many error state flags. These flags enable the system to identify invalid or corrupt data points and either discard them or automatically apply fixes.

After all filters have run an enhanced data point is created, storing all sanitized and derived values, error flags, as well as metadata that enables us to uniquely identify the versions of all software that operated upon the data point. This enables AGCHEQ to continuously improve the smart filters and continuously reprocess the data, ever evolving and fine tuning both new data as well as the entire historical dataset.

Deriving a Price Per Pound

In order to aggregate or compare products it is necessary that each product has a normalized price per pound. In the case particularly of fruits and vegetables the raw data only reports prices in prices per package, across more than 4,000 different package types. This is further complicated by the fact that some price points report a unit of sale which is different from the package, for example a bin of melons which is priced on a per melon basis. AGCHEQ has developed a multistage process for converting raw prices per package into a price per pound, taking into account a variety of input values and using different strategies depending on the product.

The process comprises determining whether the price per pound can be extrapolated from the data point by analyzing the unit of sale and package name, as is the case for data points where for example the unit of sale is “per lb” or “per kg” or the package name is “10 lb carton”. If the package weight cannot be so trivially determined, which is the case for the majority of products, proprietary weight keys and rules are then applied. The AGCHEQ Product Weight Key is a proprietary mapping of derived products to package weights, which is further enhanced by rules that enable us to modify the base package weight according to values in the data point, for example the size of the melon.

The combination of these proprietary lookup tables, rulesets, and automated analysis tools provides a price per pound for the vast majority of data points, enabling aggregation and cross comparison across thousands of products.

For each Unique Product, financial performance information for each price point is calculated and derived and stored, covering dozens of metrics including absolute and percentage price changes, multiday moving averages, and high/low values.

Once derived financial metrics are calculated, each day's prices are analyzed in bulk to detect movements that are of interest. As the agricultural markets can be highly volatile, a proprietary algorithm is used to detect movements of interest and either flag them as such or if they exceed certain thresholds, they are categorized as an invalid price point, or “bad tick”. For example, if the price per pound of Tomatoes jumps 100× for a single day, it is most likely due to an error in the raw data where a decimal was misplaced. These bad ticks are discarded.

A proprietary conversion key is created by using only the most accredited sources—principally the USDA, the Canadian Food Inspection Agency, and Land-Grant Universities. The proprietary conversion key reads all the inbound reports, knows the 400,000+ unique products' variations and their 4,093 unique package weights to convert everything into price per pound enabling an index creation process. This conversion process is done nowhere else—even the USDA avoids reporting weights in normalized price per pound.

The data converted into actionable information is delivered over an API to the purpose-built platform. Further API connections exist to tie in directly with trading portfolios, order management systems and accounting systems. The price indexes and their derivatives are used to trade stock portfolios, set contract negotiations, trigger audits, and etc.

In current food markets, there are many varieties, sub-varieties, units, grades, appearances, origins, environments, sizes, colors, and price points in various steps. Where there is a need to compare prices, it is preferable to get to a common unit. One path of getting to a common unit is to create a benchmark price, which would be the lowest of the grades. The path is a total aggregate path, it blends prices of all varieties, takes a moving average, and allows direct product comparison.

The benchmark price can be used as the basis, with the application of a simple autoregressive integrated moving average (ARIMA) statistical model and long short term memory (LSTM) network, to forecast future prices, relevant for Futures and Forwards contract negotiation, Budgeting and Business Activity Planning purposes, Operating Capital Loan generation, and Crop Insurance Contract generation. The benchmark price can also be used for creating statistical, quantitative trading algorithms or programs and can be related back to associated markets such as but not limited to the earnings, gross margins, equity and debt performance of publicly traded food-centric companies such as restaurant groups, retailers and grocers, and hotels and gaming.

AGCHEQ Data Universe

The AGCHEQ platform creates an AGCHEQ Data Universe. The AGCHEQ Data Universe covers the US Food Markets at the Farm gate, Wholesale and Retail level, and includes meat, poultry, fruit, vegetable and dairy products market data. The AGCHEQ Data Universe consists of daily recorded trades between large growers, primary processors or food distributions with institutional food service operators and retailers. All market data is verified by the USDA. The US wholesale marketplace is divided into 13 major-metropolitan markets, such as New York's Hunts Point Cooperative Market or the Los Angeles Produce Market. The International wholesale marketplace is divided into 14 major-metropolitan markets across North American and Europe. There are more than 70 major Aggregate Products that are comprised of nearly 500,000 actively traded Individual Unique Products (IUPs). These products represent all the major fresh food items consumed as determined by the USDA in addition to the nearly 200 minor Aggregate Products.

Prices are calculated and displayed in normalized prices ($/lb). Through reconversion, they are also available in their most commonly used individual industry trading packages. IUPs prices are reported without further calculation. Aggregate Product (AP) prices are equal to the equally weighted aggregate values of all available AP prices within a specific period.

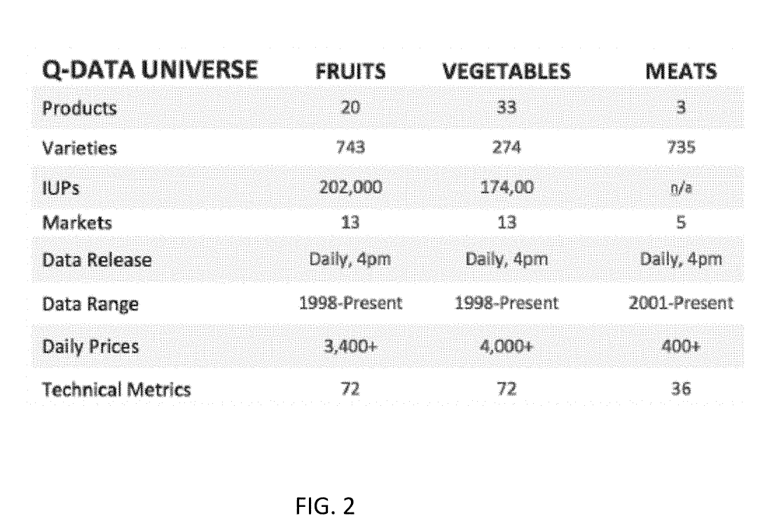

FIG. 2 provides quick facts of three main sectors included AGCHEQ Data Universe. For example, fruit sector, there are 20 Aggregate products, 743 varieties, 202,000 IUPs, and 13 markets. Data are released daily at 4 pm, data range is from year 1998 to present. There are 3,400+ daily prices in 72 technical metrics.

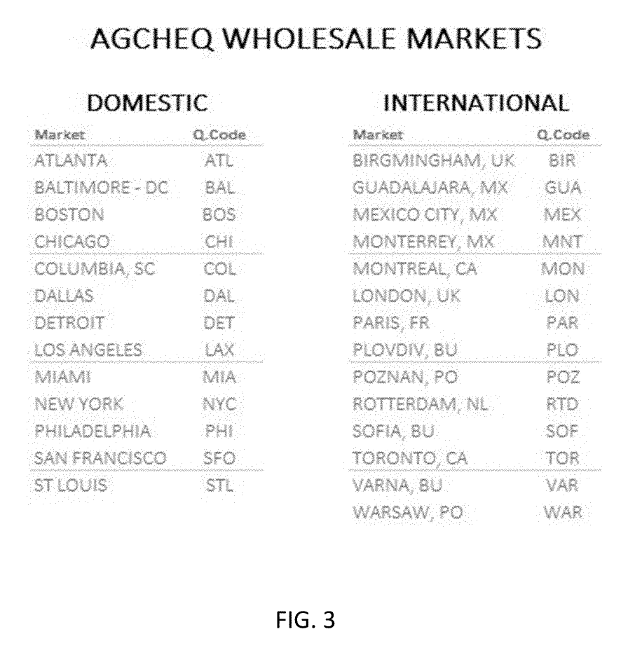

FIG. 3 is an overview of the 13 major-metropolitan domestic markets and the 14 major-metropolitan international markets. The domestic markets include Atlanta, Baltimore, Boston, Chicago, Columbia S.C., Dallas, Detroit, Los Angeles, Miami, New York, Philadelphia, San Francisco, and St. Louis. The international markets include Birmingham UK, Guadalajara MX, Mexico City MX, Monterrey MX, Montreal CA, London UK, Paris FR, Plovdiv BU, Poznan PO, Rotterdam NL, Sofia BU, Toronto CA, Varna BU, Warsaw PO. The respective codes for these markets in the AGCHEQ Data Universe are also provided.

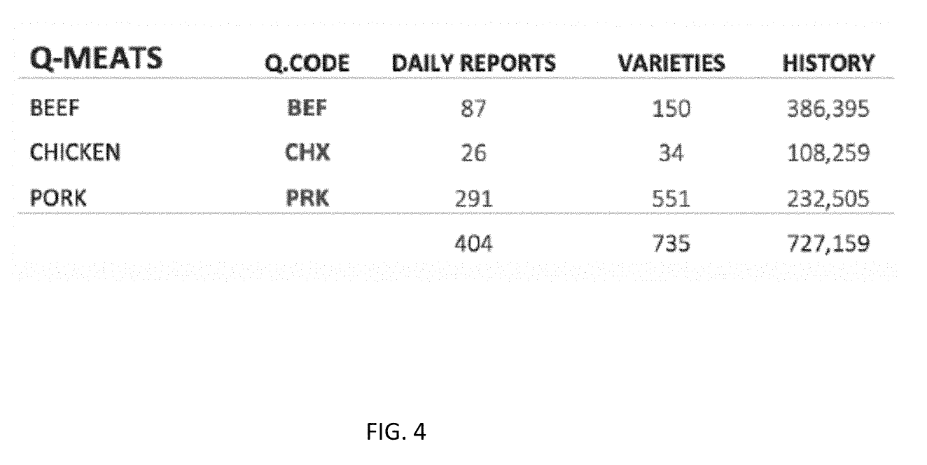

FIG. 4 is an overview of the meat sector in the AGCHEQ Data Universe. Beef, chicken and pork are included in the meat sector. Numbers of daily reports, varieties, and history reports for each type of meat are provided.

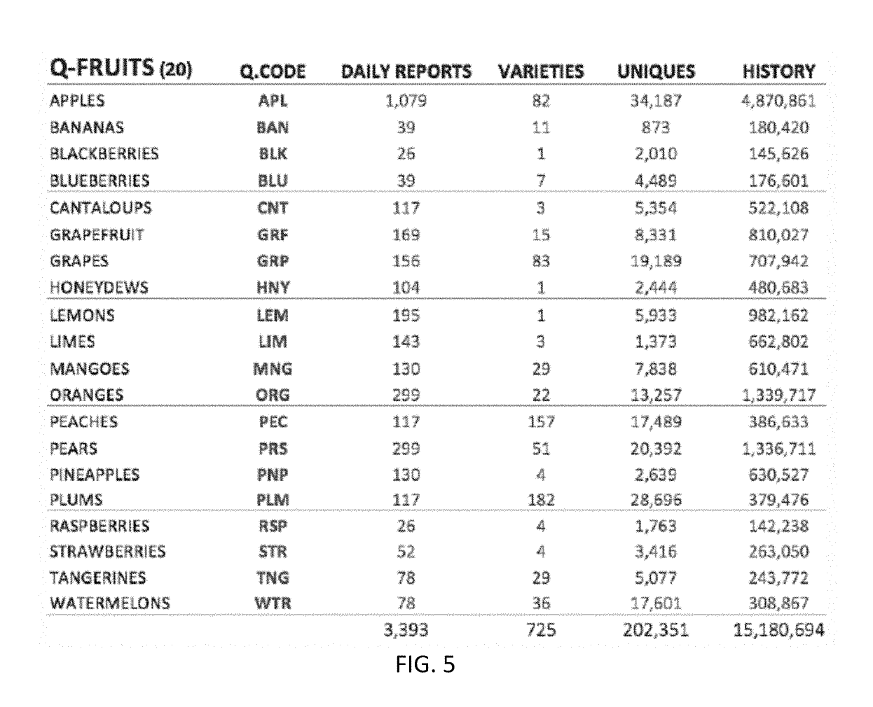

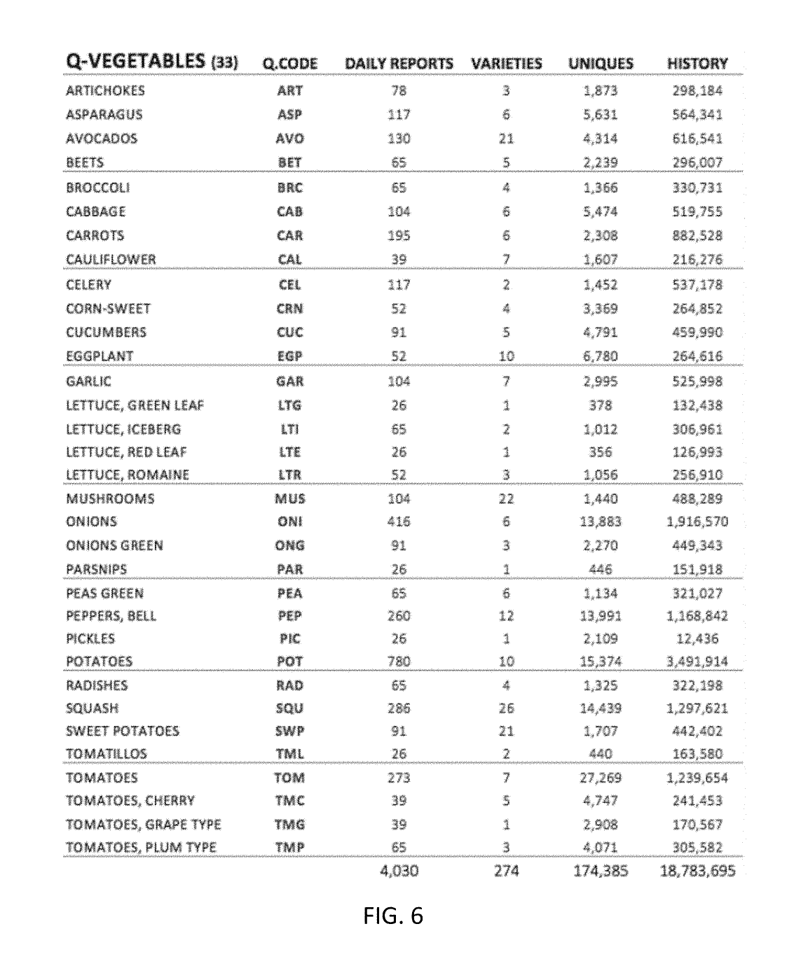

FIG. 5 is an overview of the fruit sector in the AGCHEQ Data Universe. Numbers of daily reports, varieties, uniques, and history reports are provided for each of the 20 fruits. Similarly, FIG. 6 is an overview of the vegetable sector in the AGCHEQ Data Universe.

Additionally, there is an AGCHEQ Tropical Data Universe including at least 185 products, representing tens of thousands of unique products. Note that data on many items may be sparse and not updated on a regular basis. Prices are calculated and displayed in normalized $/lb. Through reconversion, they are also available in all their commonly used individual industry trading packages. IUP prices are reported without further calculation. AP prices are equal to the equally weighted aggregate values of all available AP prices within a specific period.

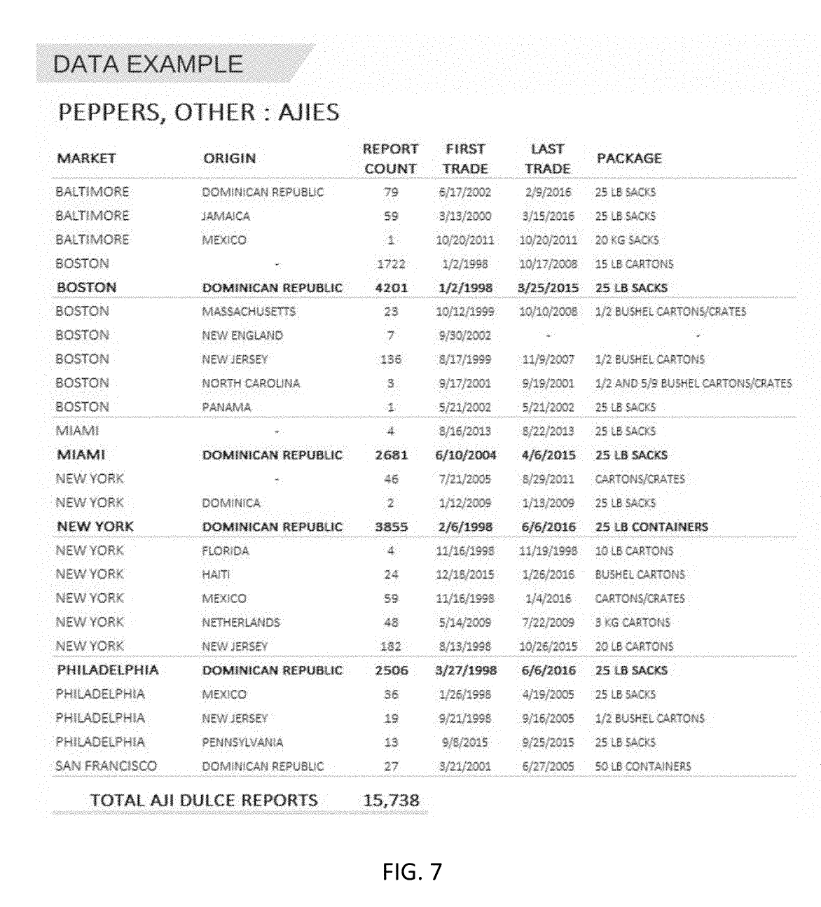

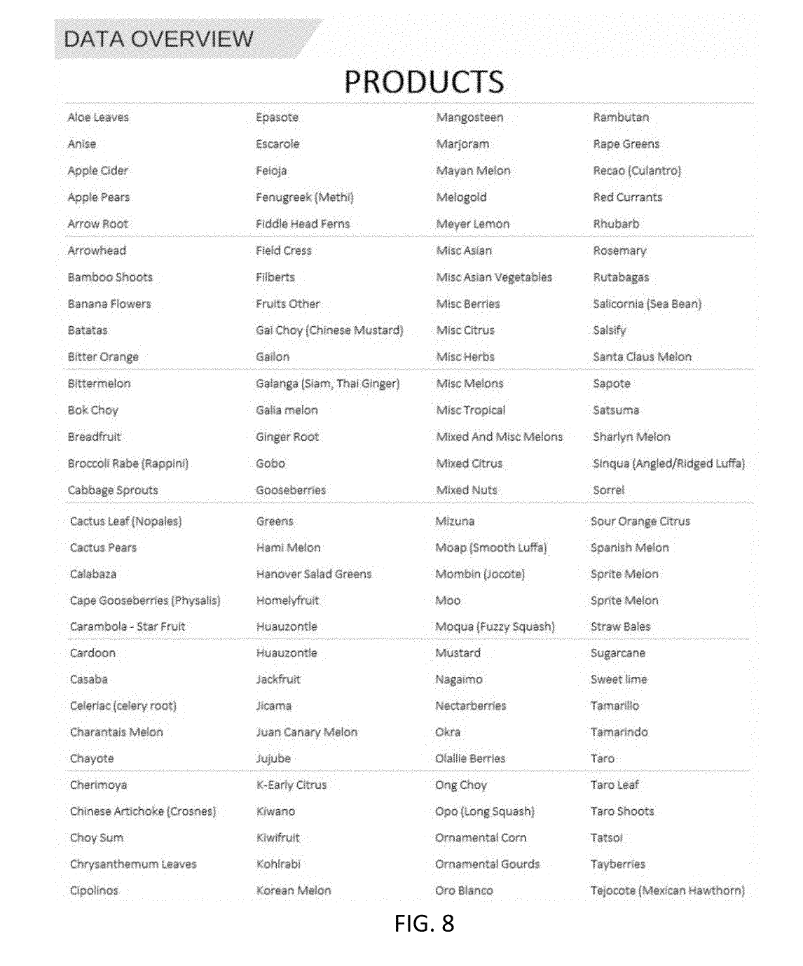

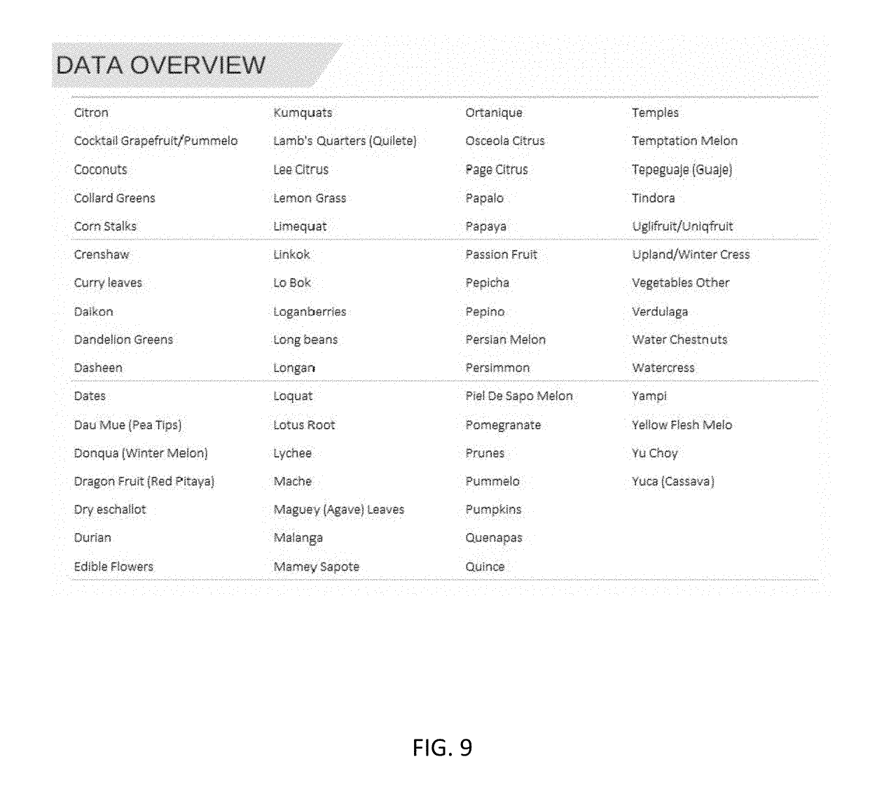

FIG. 7 is a data example for the AGCHEQ Tropical Data Universe. In the data example, data for aji dulce peppers at each market are listed with their origins, number of reports, first trade date, last trade data and package sizes. FIGS. 8 and 9 list out the 185 products in the AGCHEQ Tropical Data Universe.

AGCHEQ Index Universe

The AGCHEQ platform create an AGCHEQ Index Universe. The AGCHEQ Index Universe are representative cost index baskets and gross margin indicators, covering the US food and hospitality sectors.

The AGCHEQ Index Universe are proprietary volume weighted average price indices of the recorded prices of any given constituents' product inputs and/or outputs. The composition and geo-location of each company cost index is unique to each index and to each user and all price market data is verified by the USDA. Sector indices are aggregations of underlying company cost indices or Aggregate Product prices, intended to give further reference.

Prices are calculated according to either equally weighted average pricing, aggregation or proprietary volume weighted average pricing and are displayed in normalized prices ($/lb). Index values and technical metrics are calculated daily, disseminated no later than 17:00 EST.

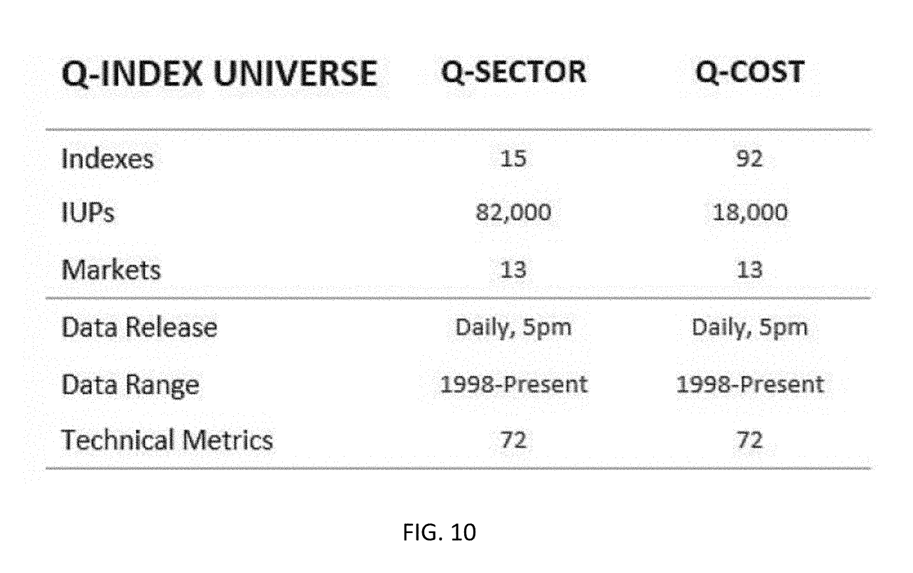

FIG. 10 provides quick facts of the AGCHEQ Index Universe. For sector indices, there are 15 indices, 82,000 IUPs, and 13 markets. Data are released daily at 5 pm, data range is from year 1998 to present with 72 technical metrics. For company cost indices, there are 92 indices, 1,000 IUPs, and 13 markets. Data are released daily at 5 pm, and data range is from year 1998 to present with 72 technical metrics.

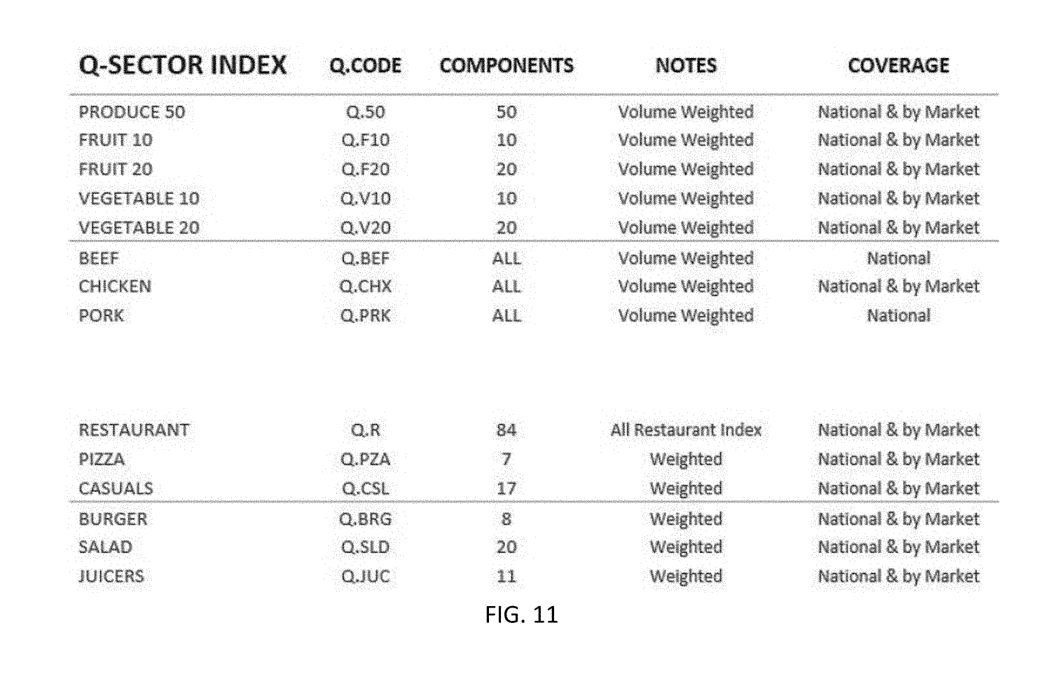

FIG. 11 is a sector overview of the AGCHEQ Index Universe. Components, notes and market coverage are provided for each sector index.

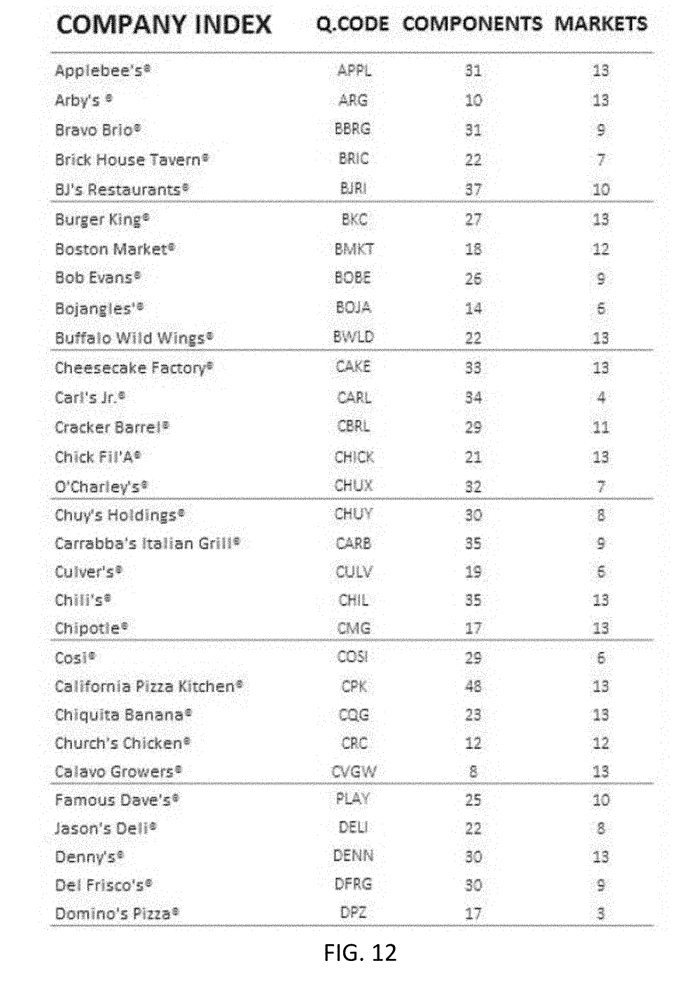

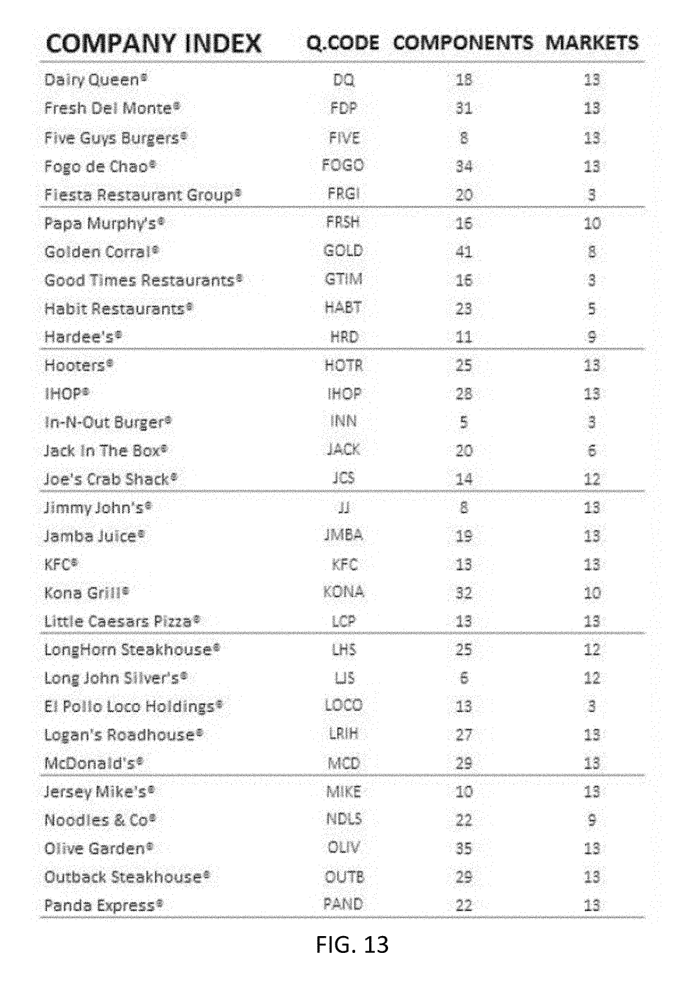

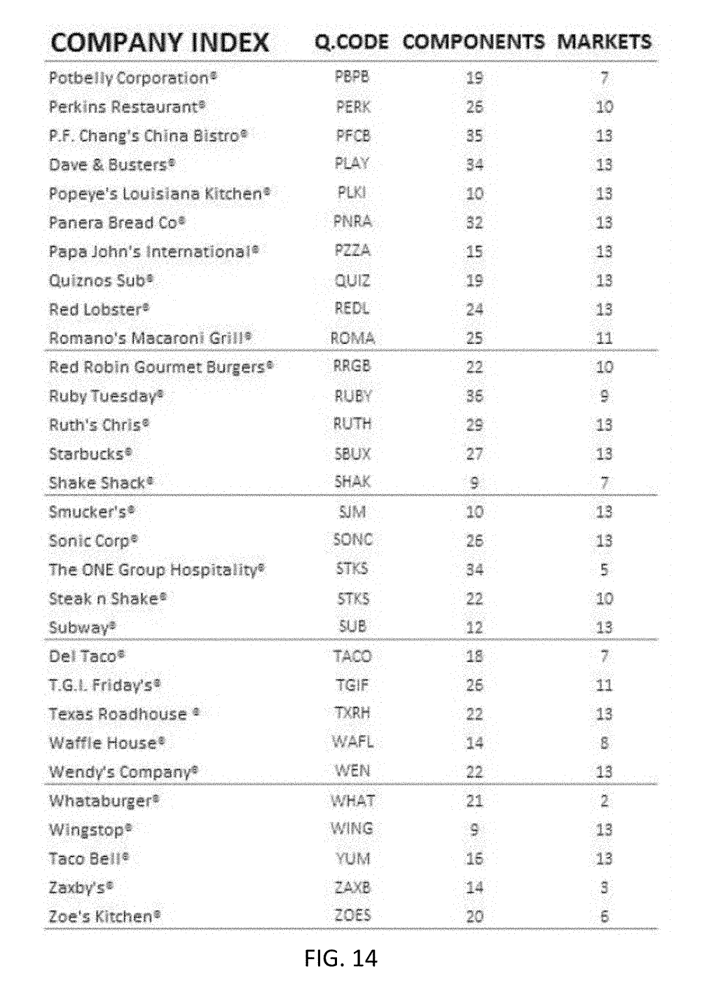

FIGS. 12-14 provide an overview of company cost index of the AGCHEQ Index Universe. Number of Components and number of markets included in each of 90 restaurant indices are provided.

AGCHEQ Real Products

The AGCHEQ platform defines Real Products by taking all information from a USDA price listing except: report date, market, prices, and price comments. They represent an actual product that was sold on a given day in a given market and was considered distinct enough that the USDA recorded it as a separate line item. When paired with a market and report date a Real Price can be quoted for any given Real Product, except in the case where there was no USDA data reported for that product that day in that market, or the offerings were insufficient to quote.

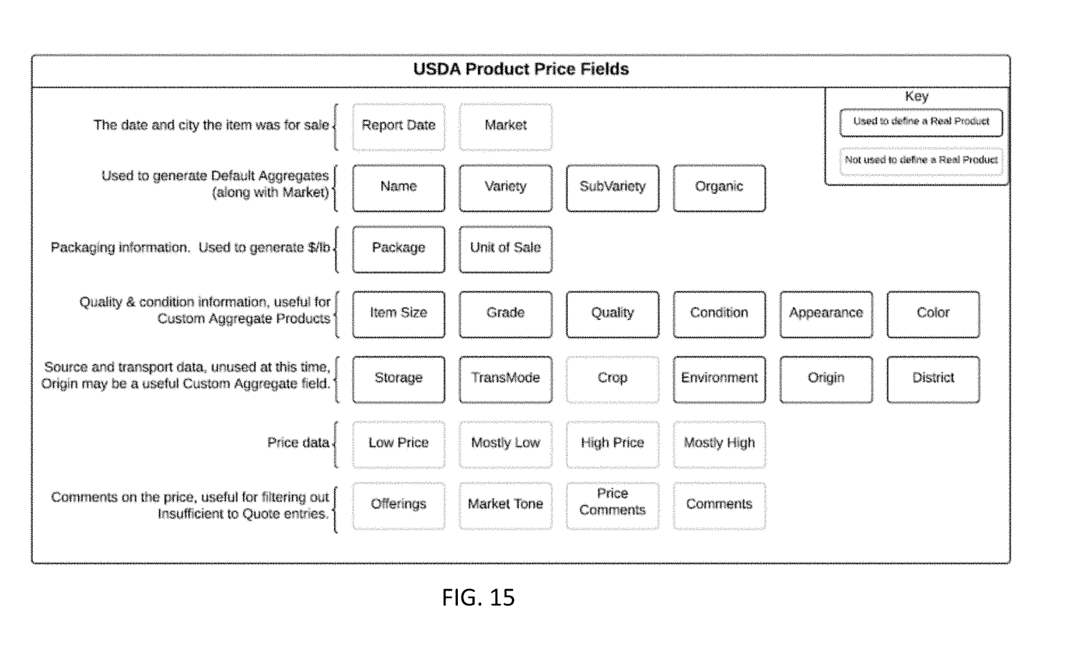

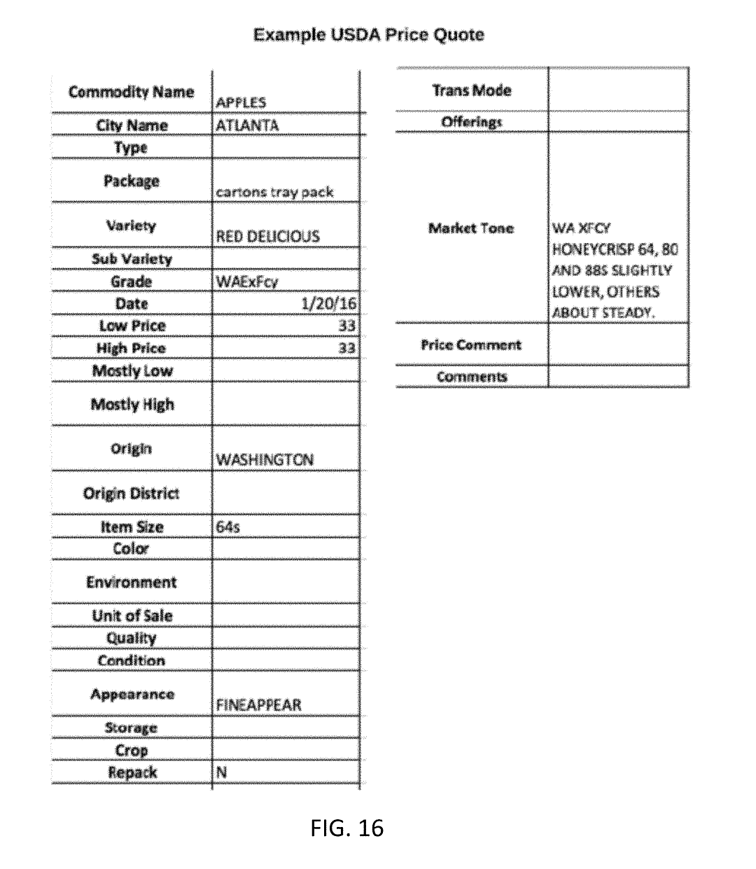

FIG. 15 is an illustration of USDA product price fields parsing from a USDA price listing. Fields with gray lines, such as report date, market, price data and comments on the prices are not used to define a real product. All fields with a dark black line around them are hashed together to produce a Unique Product ID which uniquely identifies a specific Real Product. FIG. 16 is an example of USDA price quote.

Although the phrase “comparing apples to apples” is used colloquially to describe a comparison where both items are directly comparable, the USDA has reported prices for over 34,000 distinct apple line items. When a farmer trades Apples in the marketplace he may be bringing organic Gala Apples graded Extra Fancy size 64 s that were grown in Washington and are packaged in a Carton Tray Pack. Users may also be informed that the apples are red, that they were grown in a greenhouse, that they are of good quality and fine condition and fine appearance. This set of information, along with the date, the market they were traded in, and the price are all included in a single data point.

However, many end users do not want to see the prices for such a specific item either by choice or in the frequent case of end-buyers, because they have not been supplied with such detailed product information from their supplier to begin with, they'd rather simply have us answer questions like “What is the price of Gala Apples in New York?” or perhaps more specifically “What is the price of organic Gala Apples grown in Washington in New York?” In order to answer these questions AGCHEQ analyzes each data point, and discards certain values in order to determine a specific product for the data point. For example, the package type of a data point is ignored when determining the product, as a specific type of gala apple could be packaged in many different ways (boxes, cartons, bags, etc) without it becoming a different type of gala apple. By analyzing the entire historical dataset AGCHEQ is able to derive the complete set of products being traded in this way, assigning each specific product a Unique Product Identifier (UPI).

Once the products are identified, each data point price is assigned to one of these UPIs. For any given day, an UPI may have one or more price points, as for example the same specific type of organic gala apple described above may have been traded in cartons and bags. The normalized price per pound of these individual data points is then used to derive an average price per pound for a unique product on a given day.

AGCHEQ Aggregate Products

By normalizing all raw input data, and assigning each price point to a unique product AGCHEQ is able to create a standard container—the product—which is assigned data describing prices over time. Every product in the AGCHEQ system has an average price per pound derived from the data points it is associated with. At the most specific level that is a Unique Product, only a handful or perhaps even only one price per day is being considered. However, this normalized structure enables AGCHEQ to do something much more powerful.

Products can themselves be aggregates of other products, for example an average of all Gala Apples traded, regardless of size or origin or other factors. This Gala Apples Aggregate Product averages the price per pound of all of the Gala Apples unique products and itself is treated as any other product in the system—it receives a full set of derived financial metrics, including price charts and trends.

However, not all Unique Products can be seamlessly aggregated. Often certain varieties, origins, sizes, or organic products are much more expensive than the commonly traded alternatives. Aggregating these products together would lead to a distorted average price per pound that would not reflect anything actually traded in the market. Therefore, AGCHEQ hand creates each larger Aggregate Product to ensure that for example a quote for Apples—New York would have a price per pound that reflects the typical market price for Apples traded in New York. These hand-crafted Aggregate Products are referred to as Q Prices, and often incorporate dozens of rules excluding Unique Products for many different criteria in order to ensure a consistent reliable price.

The “Russian nesting doll” approach to products, allowing them to aggregate other products, enables AGCHEQ to provide end users with the ability to create custom portfolios of products. These portfolios are themselves aggregates of the products they contain, weighted according to the user's preferences. Like any other product in the system, a full set of derived financial metrics are created for each portfolio, enabling users to view summaries, charts, and an AGCHEQ Price for their entire portfolio.

In a similar fashion, AGCHEQ also provides Indexes that aggregate together multiple types of products to provide insight into a particular region, industry, company or another facet. These indexes can also be combined themselves into other indexes or into user portfolios, enabling users to rapidly summarize and stay abreast of changes in complex markets.

Aggregate Products are containers that average one or more Real Products that share various characteristics (e.g. organic, name, variety, sub-variety). In AGCHEQ, there are four different kinds of aggregate products used as organizational buckets: (1) Default Aggregate Products (system defined), (2) Custom Aggregate Products (user defined), (3) Indices (both system and user defined), and (4) Portfolios (one per user). They vary only in the way they are created and managed, otherwise they are all just different names for an Aggregate Product.

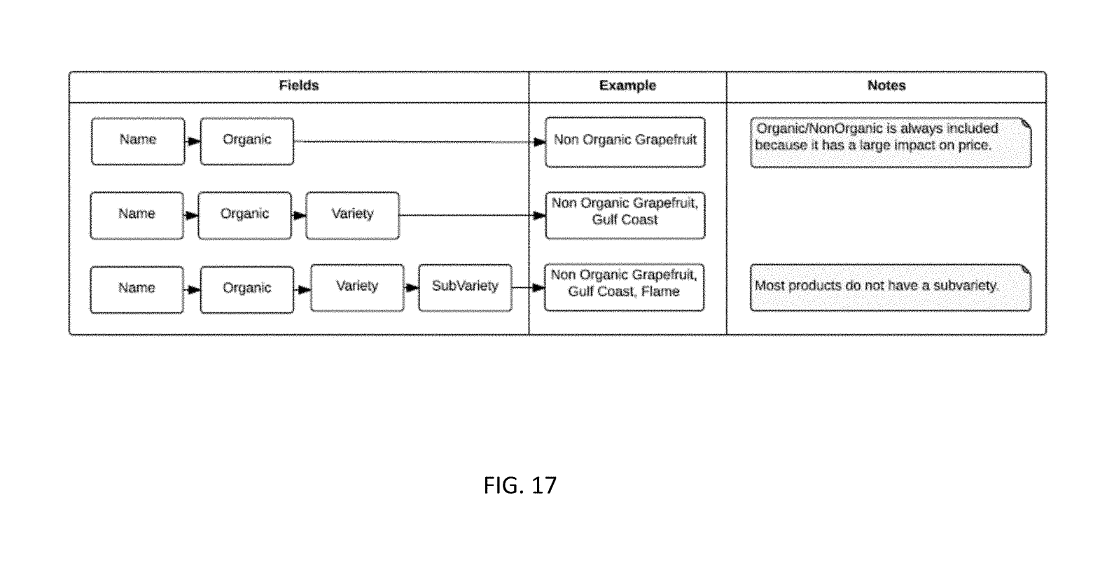

Default Aggregate Products are created by the system automatically based on all Real Products. FIG. 17 is an illustration of creating Default Aggregate Products in one embodiment of the present invention.

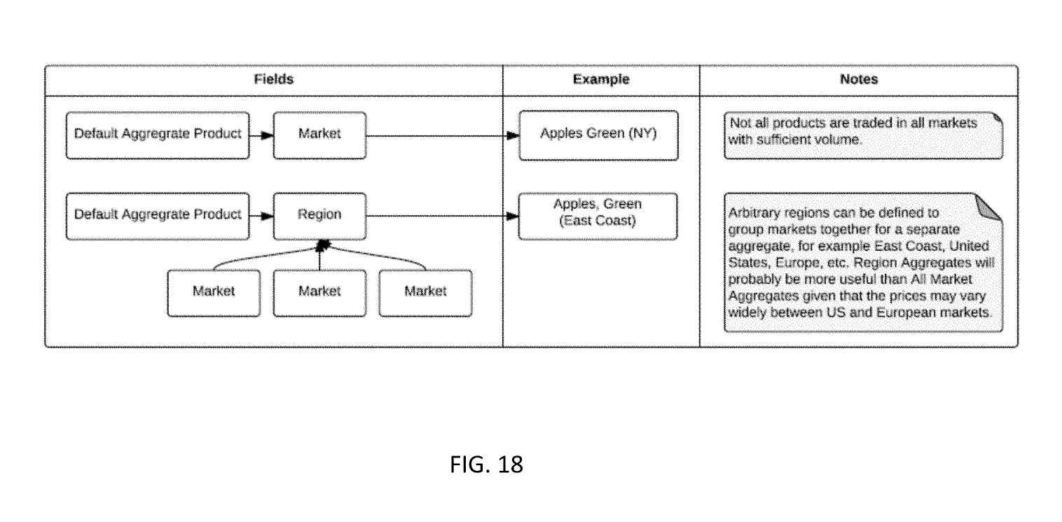

Market or Region Specific Aggregate Products are also created by the system automatically, by combining all available markets and regions with all available default aggregate products. FIG. 18 is an illustration of creating Market or Region Specific Aggregate Products in one embodiment of the present invention.

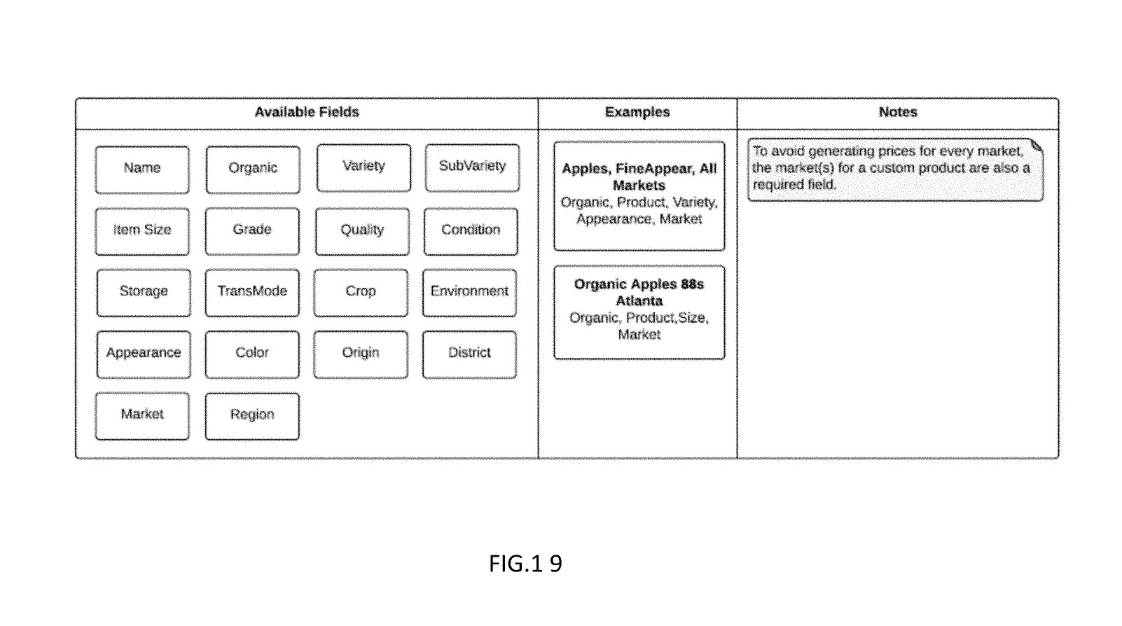

Custom Aggregate Products are created by users by selecting from a list of fields. FIG. 19 is an illustration of creating Custom Aggregate Products in one embodiment of the present invention.

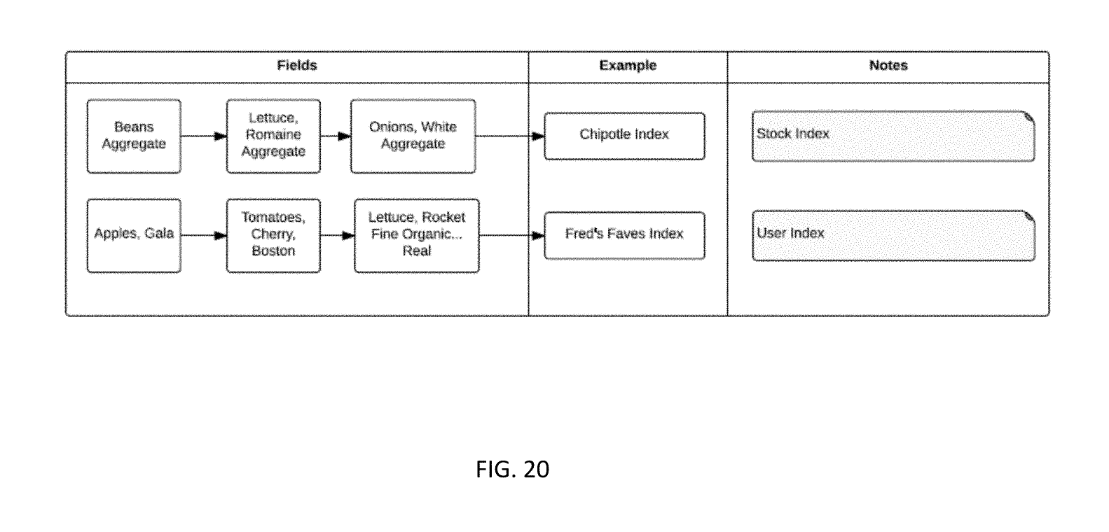

Indices come in two varieties: company-specific and user-defined. Company indices are created by AGCHEQ and contains products that are relevant to a specific company. User-defined indices are user created and contain whatever mix of aggregate and real products the user chooses. FIG. 20 is an illustration of creating a company index and a user index in one embodiment of the present invention.

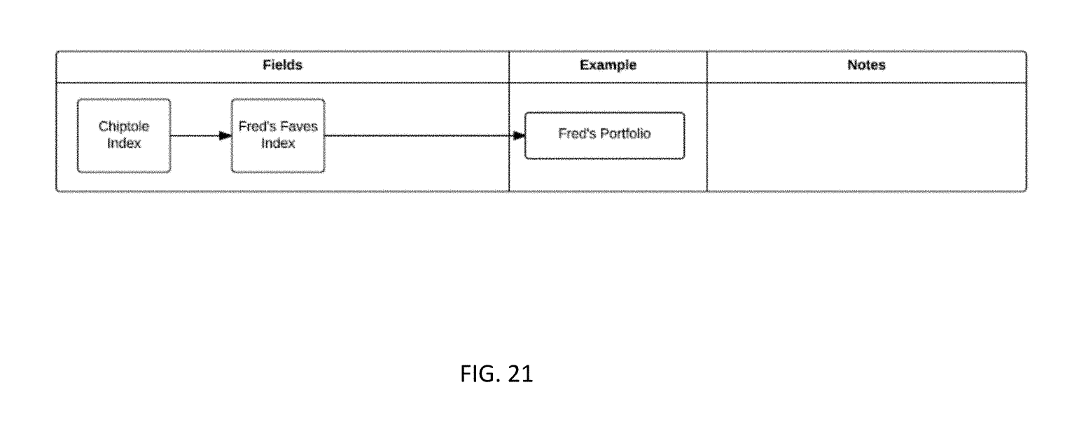

Each user has one portfolio which contains all of the indices that they have added or created. FIG. 21 is an illustration of creating a portfolio in one embodiment of the present invention.

AGCHEQ Real Price

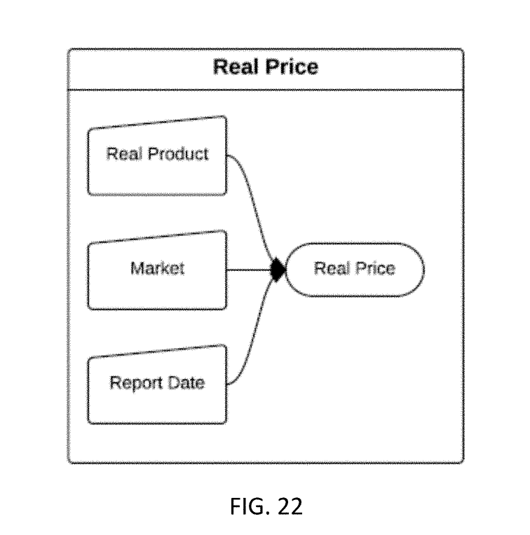

When paired with a market and report date a Real Price can be quoted for any given Real Product, except in the case where there was no USDA data reported for that product that day in that market, or the offerings were insufficient to quote in which case the most recent price available is presented. FIG. 22 is an illustration of quoting a Real Price for a Real Product in one embodiment of the present invention.

AGCHEQ Aggregate Price

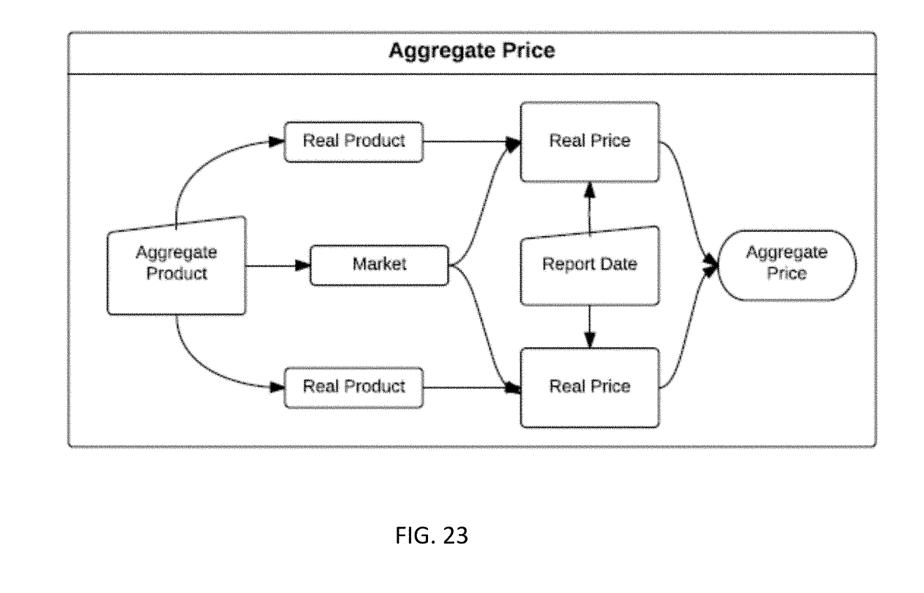

When paired with a market and report date an Aggregate Price can be quoted for any Aggregate Product, except in the case where the Real Products that make up the Aggregate Product do not have Real Price data for that date. An individual Aggregate Price may therefore be an average of dozens of USDA price data line items on any given day. FIG. 23 is an illustration of quoting an Aggregate Price for an Aggregate Product in one embodiment of the present invention.

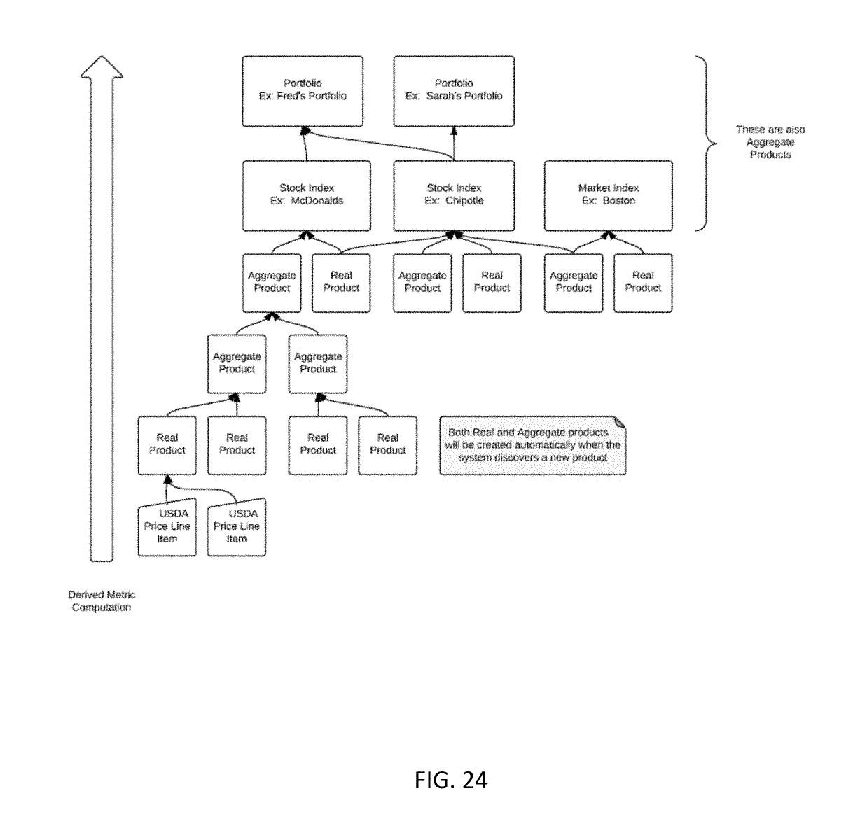

FIG. 24 is a flow chart showing a derived metric computation process for Real Products and Aggregate Products. USDA price line items are used to generate Real Products, which are used to create Aggregate Products, both of which are used to create indices, which are combined to create portfolios. This process shows how single unique products that enter in and out of the market place according to supply conditions can be aggregated to provide a view into the overall market. Hundreds of thousands of individual unique products that have been traded millions of times can be aggregated into increasingly simple products as determined by their identifiers and then become part of a Portfolio or Menu aggregate basket.

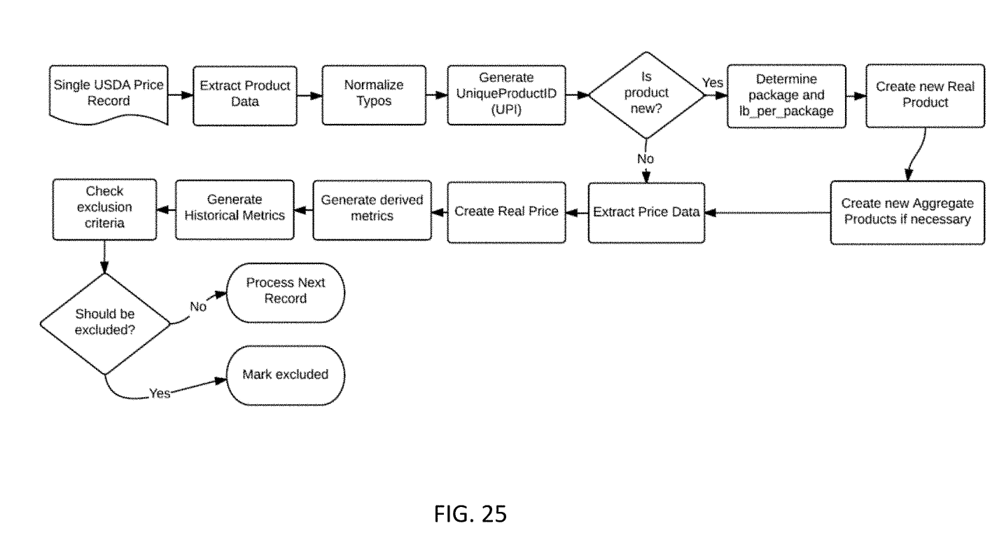

FIG. 25 is a flow chart showing Real Product and Real Price harvesting.

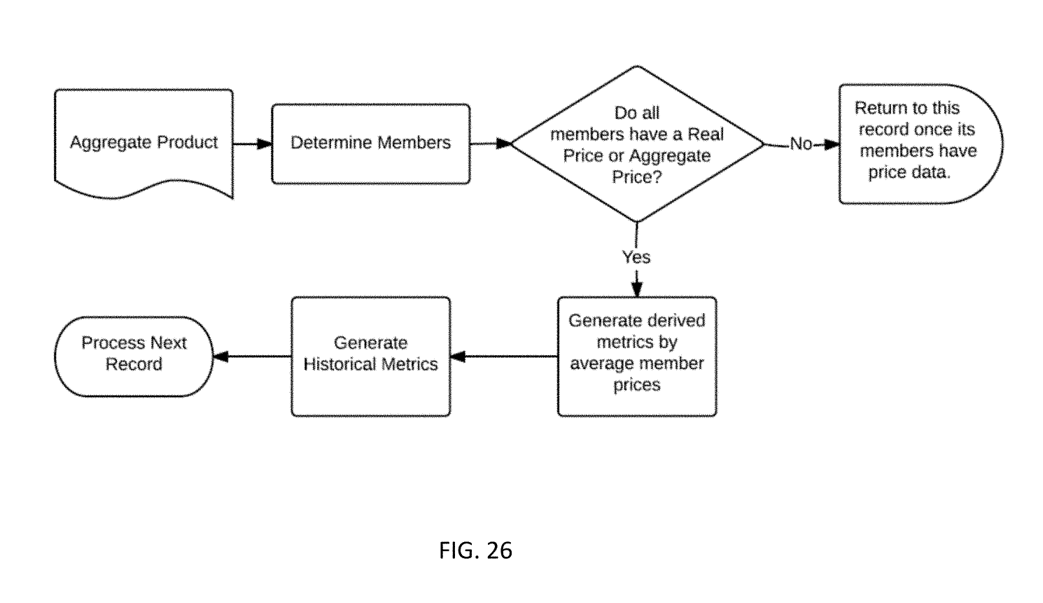

FIG. 26 is a flow chart showing Aggregate Price calculation phase.

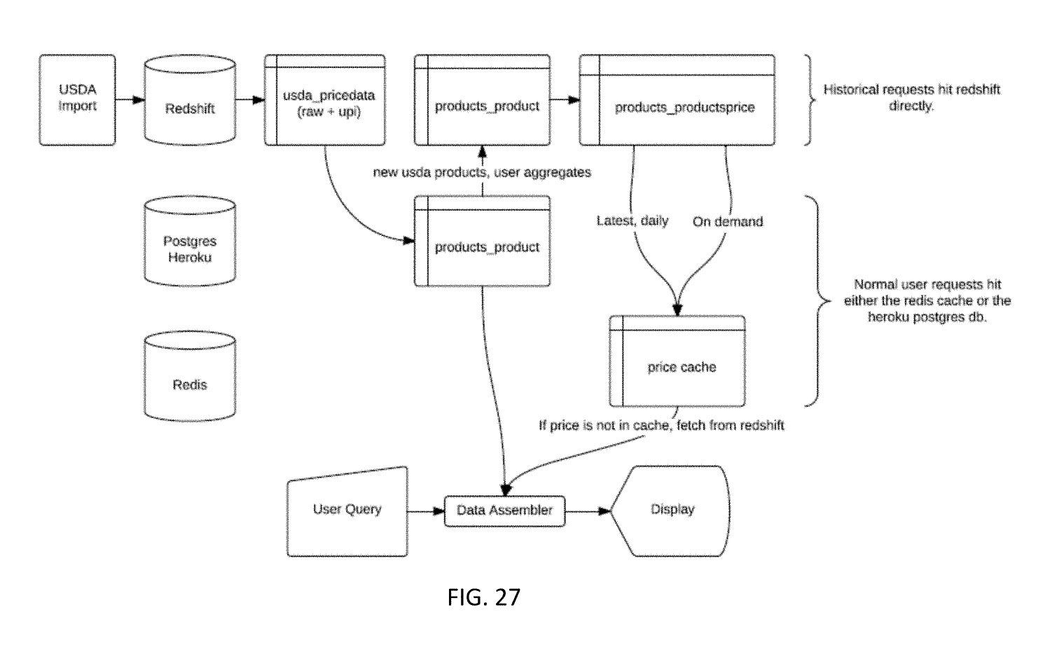

FIG. 27 is an illustration of a process over the proprietary platform in one embodiment of the present invention.

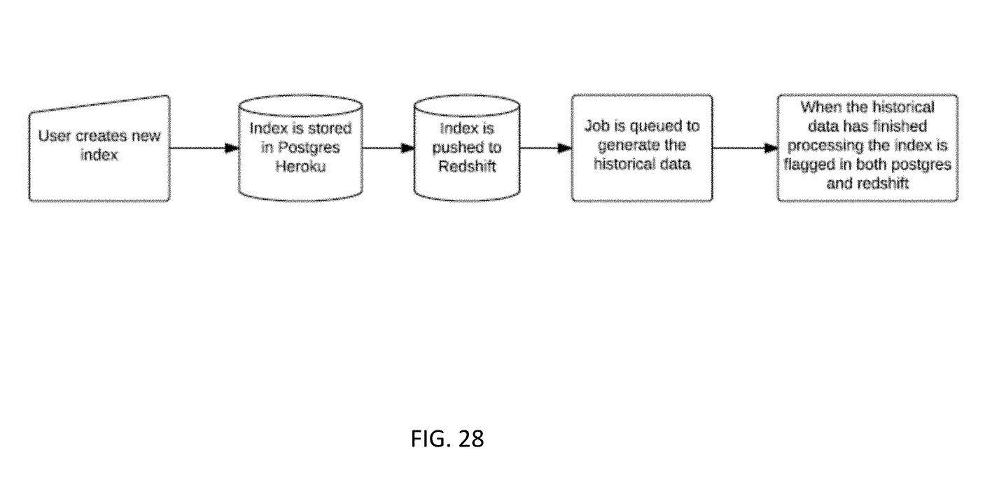

FIG. 28 is a flow chart for creating a new index.

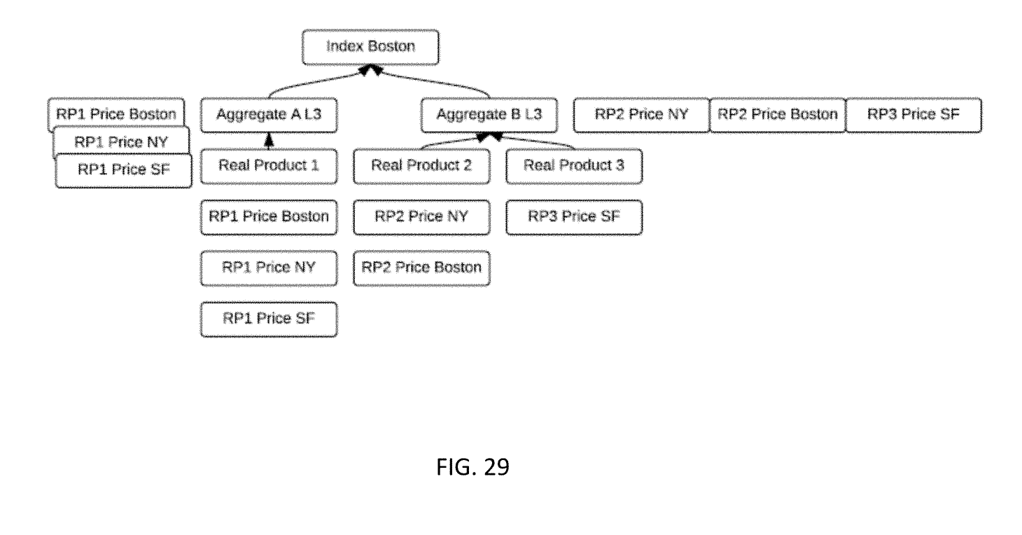

FIG. 29 is an example of creating an index composed of a portfolio of Boston-specific prices including certain Real Products.

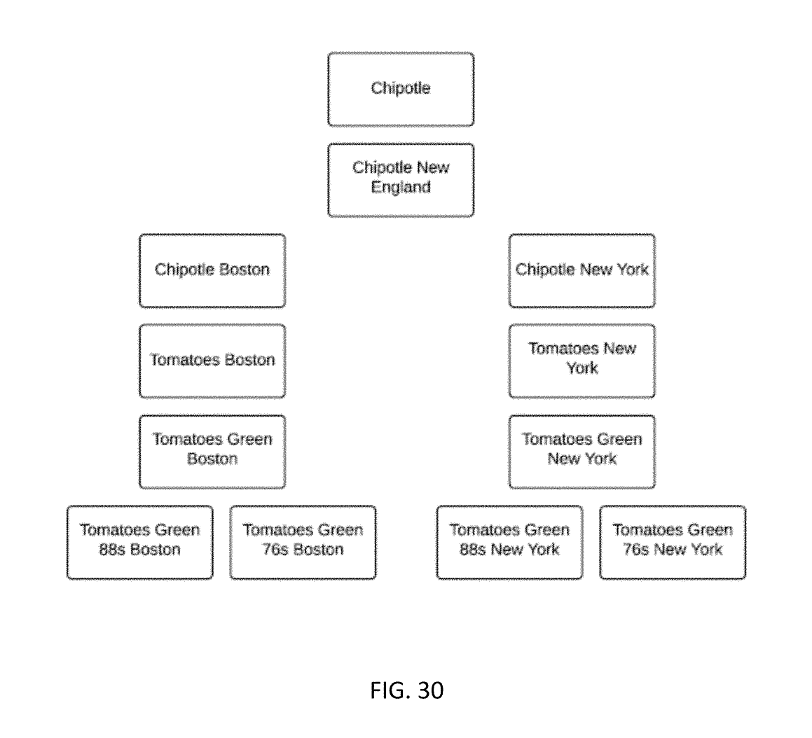

FIG. 30 is an example set of real and aggregate products. Individual unique products become aggregated to reflect the broader market conditions. In this example, all the individual tomato offerings in certain markets become normalized and aggregated into broader tomato prices. A user, in this case identified as “Chipotle” has tomatoes on their menu and so wishes to track not just the many individual prices of tomatoes, but an average aggregate, not just in every market in which they operate, but for their overall company.

Price Forecasting Process

It is always better to have multiple models in mind to guide a decision, as they can lend more insight to the decision making process than having only one model, or none at all. In one embodiment, three models are constructed for forecasting the commodity prices found in AGCHEQ's database. They are presented below in order of their perceived ability based on academic literature: Empirical Mode Decomp with an Artificial Neural Network (Yu et al 2007) and Wavelet Transformation with a Hidden Markov Model (De Souza e Silva 2010), which are incorporated by their entirety.

The Artificial Neural Network (ANN), as the name implies, is a learning model based on nature's preeminent supercomputer: the brain. The human brain receives six signals: sight, sound, smell, taste, tactile sensation, and mentation. These signals are then sent to an array of interconnected neurons. Depending on different signals the neurons will either light up or stay dark. This then triggers adjacent neurons to react to the first bank of neurons' signals. After electrical impulses cascade around, the brain produces a thought or makes a decision. If a new experience is registered, then new rules and links are formed across the brain's neurons. An ANN is completely analogous to the brain in terms of learning, having neurons, and creating an output or decision. But the question remains: what signals are transmitted to the ANN? It cannot see, hear, touch, etc. All the users have in the context of forecasting commodity prices are the historical prices. With Empirical Mode Decomposition (EMD), a single price time series is turned into multiple sine functions, which due to their periodicity are very predictable. Feeding these sine functions into the ANN is the same as the human brain seeing and hearing. With these signals, the ANN can create predictions when new data comes into existence. This model is for medium term forecasting, i.e. 2-3 weeks. The ANN forecasting process can be summarized into the following arrow flow chart: Price→EMD→Sine Wave→ANN→Forecast. Results are improved with the addition of a long short term memory (LSTM) network which adds an extra dynamic memory component which can look back on how it learned instead of only knowing what the sum total of its knowledge is.

The Hidden Markov Model (HMM) starts off similarly to ANN/EMD. It uses a wavelet transform to denoise the price data. Think of that as removing static from a radio broadcast. This step is necessary to divine the overall trends without being caught up in minute day-to-day oscillations. This is used instead of a moving average because moving averages can have a significant lag to non-averaged data.

In a regular Markov Model, there are a defined finite number of states that a system can be in, and the probabilities of transitions between states are defined. For example, if an item is in State-1 at time t, it is known with a certain probability that if it will remain in State-1 or transfer to State-2 or State-n etc. at time t+1. These are very helpful for predictions because Markov Models tend toward an equilibrium distribution.

An HMM is different only in the fact that these states cannot be observed directly, hence the word ‘hidden’. But these states can transmit signals that indicate which state the system is in. Here is an example in the context of commodity prices. Let's say that the apple market is in either one of two states: good or bad. What does that mean? Well, it's abstract, and can't be measured, so these states are hidden. But the day-to-day price changes can be observed: decreasing, flat, or increasing. Using the math associated with MINI and based on historical price observations, forecasts about the trend of the prices over a 20-30 day period can be made. This model will not produce a single number as a forecast but it will give a probability distribution of the change in price from now until the forecast period. The HMM has been shown to be a powerful tool in forecasting trends. The HMM forecasting process can be summarized into the following arrow flow chart: Price→Wavelet→HMM→Forecast.

The Support Vector Machine (SVM) is very similar to an ANN. For an SVM, the price data is represented as a vector, or list, and compared to other existing support vectors generated via machine learning. Depending on the similarity between the price vector and each support vector the future path of the price vector is forecast. Importantly, the SVM is operable to generalize for cases it has not yet encountered. The SVM is operable to learn, adapt, and generalize, to be used for long-term forecasts on the order of months to years.

AGCHEQ Platform Application

The proprietary platform provides a mechanism that provides over a distributed cloud-based network access to any market participant an accurate, unique and verifiable independent price benchmark for any product in real time.

The platform is operable to process more than about 20,000 daily market updates in 72 technical metrics and to provide custom benchmark analysis with customizable platform displays in real time. Additionally, all prices are available in dollar per pound ($/lb). The platform provides web application, as well as secure iOS and Android mobile application.

Registration and use begins with a signup process where usernames and corresponding passwords are generated based upon inputs by users. The platform automatically recognizes users from a contact database, prepopulating form fields with previously identified, extracted and saved information, such as by way of example and not limitation, Business Name, Address, Menu Items/Crops Harvested. The platform geo-locates each user to the nearest specific wholesale market(s). The platform collects and aggregates all available market data into a single database where it is algorithmically sanitized to catch and filter known human errors. The user's custom data is calculated, aggregated, and displayed in real time on a user's unique platform interface or graphic user interface on a display of a mobile communications or computing device. The platform updates all prices, technical metrics and graphical metrics every day in real time. The user can create custom derivative products or portfolios to represent their unique crop mix, harvest, output etc. The platform pushes the data out real time to a cloud platform, accessible anywhere and to the user's unique mobile device. Forecasting algorithms present statistically likely (95% confidence) price ranges the user can use to prepare budgets, negotiate forwards and futures contracts, and obtain operating capital loans or risk management products such as crop insurance.

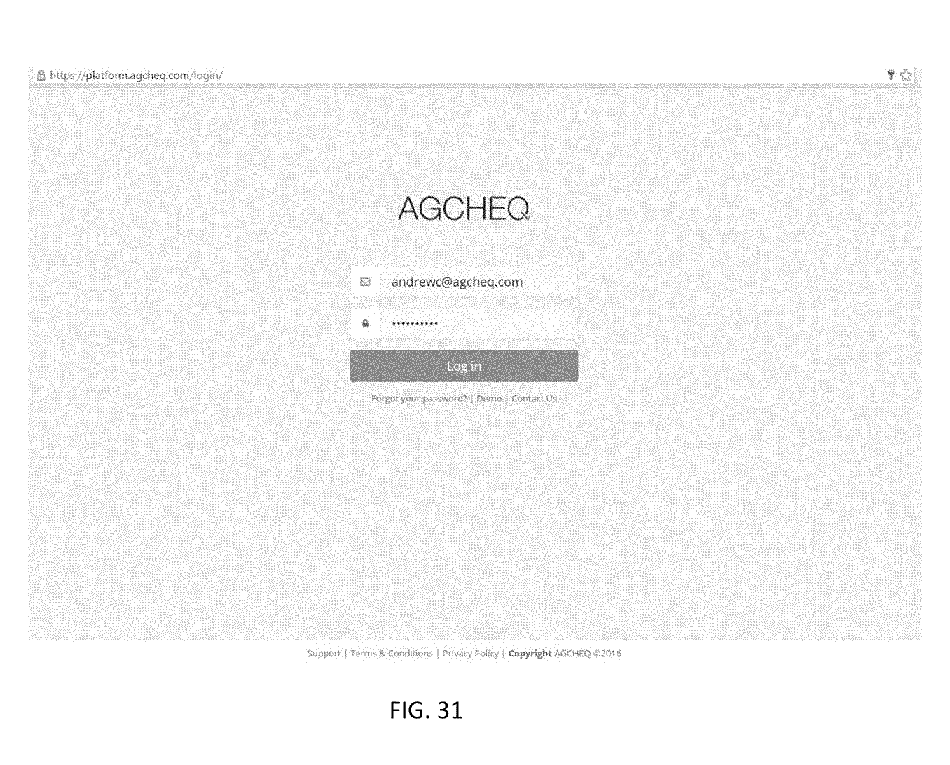

FIG. 31 is a screenshot for platform login over a web application.

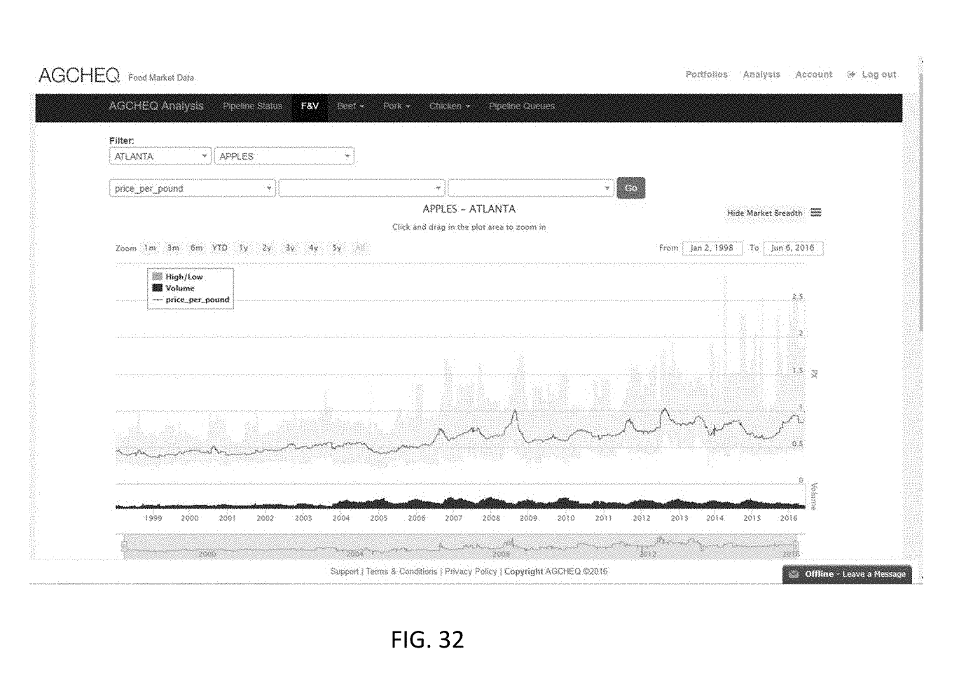

FIG. 32 is an interface for fruit and vegetable analysis. In this figure, benchmark prices for apples in Atlanta market are analyzed based on supply volume over the period from Jan. 2, 1998 to Jan. 6, 2016.

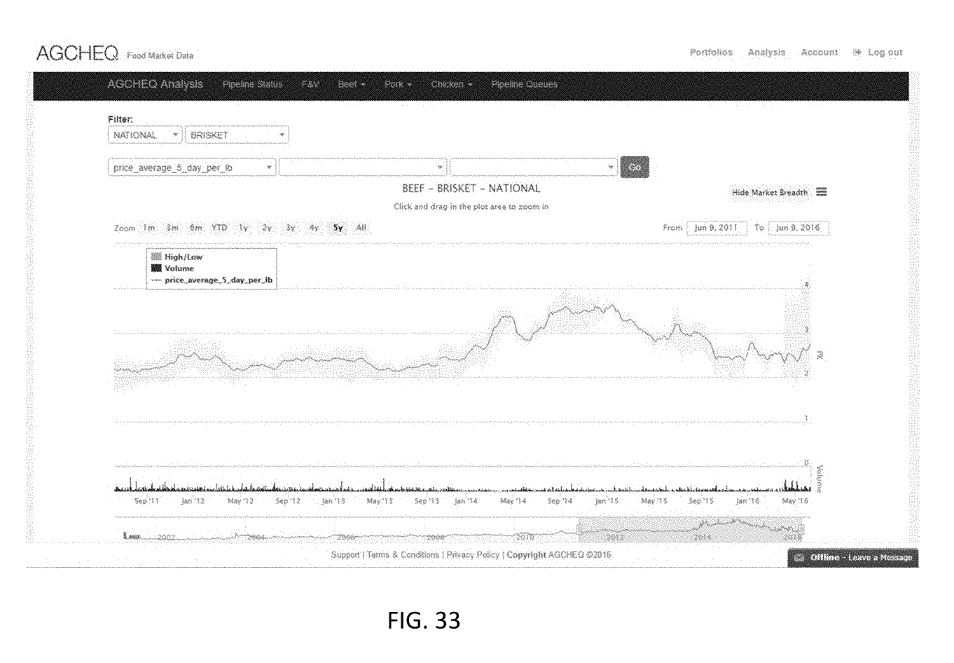

FIG. 33 is an interface for beef analysis. In this figure, benchmark prices for brisket nationally are analyzed based on supply volume over the period from Jun. 9, 2011 to Jun. 9, 2016.

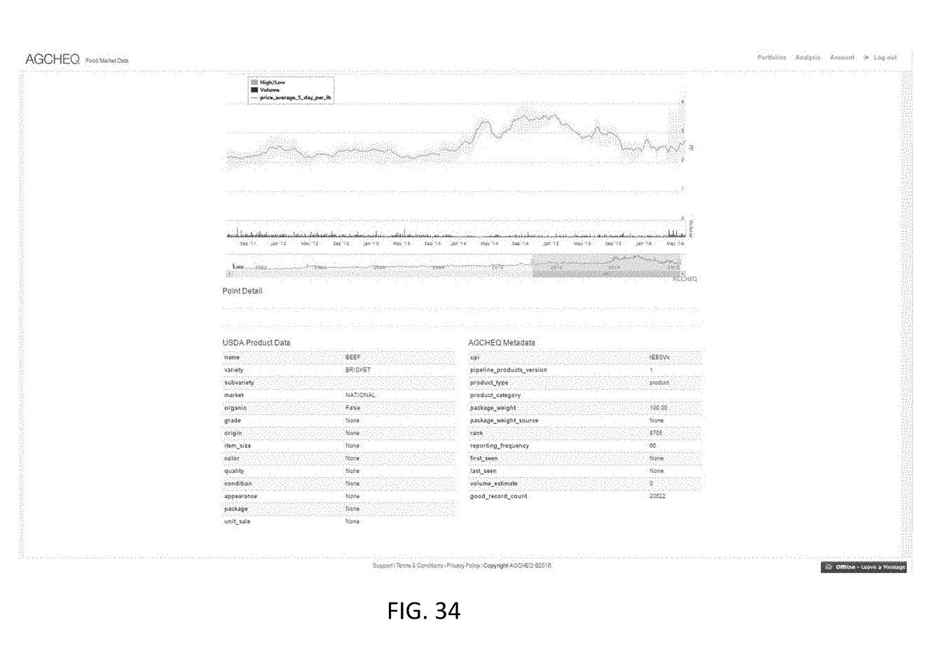

FIG. 34 is USDA product data and platform metadata for the brisket analysis nationally.

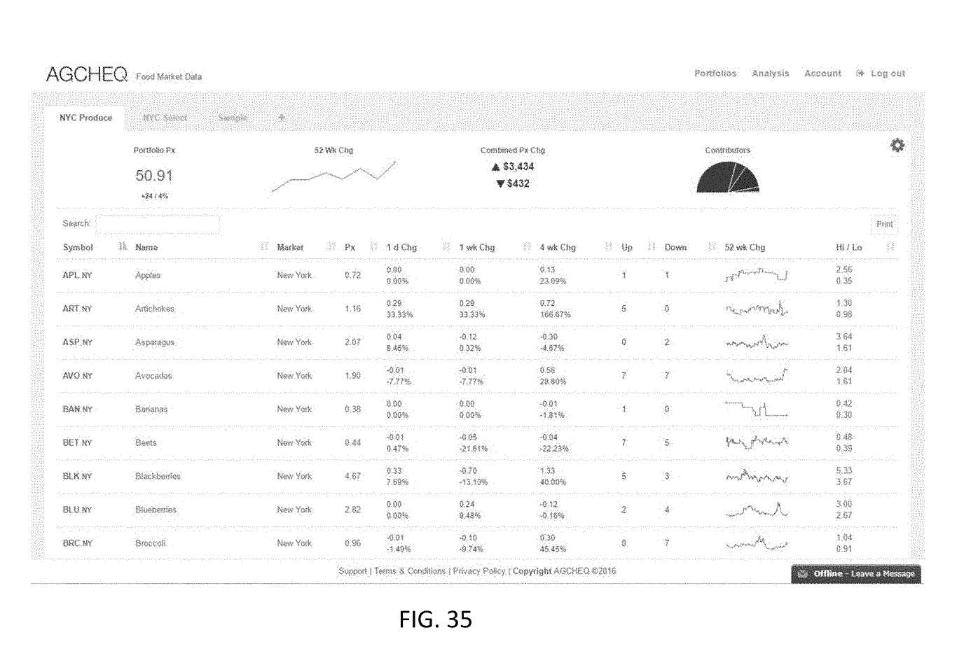

FIG. 35 is a screenshot of a portfolio of a leading New York City (NYC) restaurant group composed of its major purchased perishable ingredient categories.

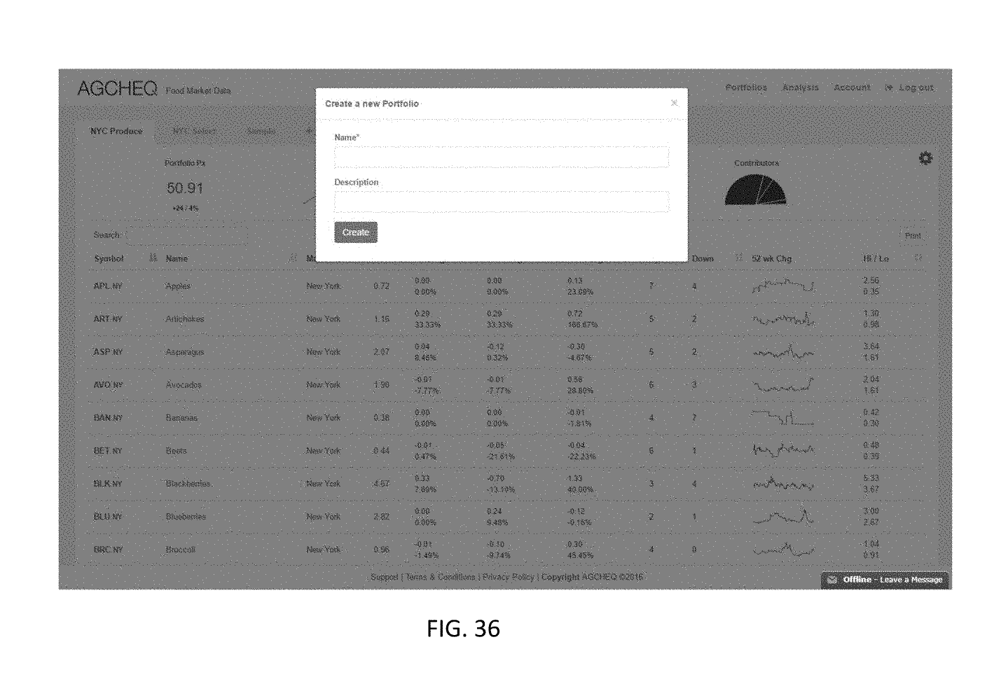

FIG. 36 is a screenshot of creating a new portfolio. This pop-out window enables users to assign custom names and descriptions.

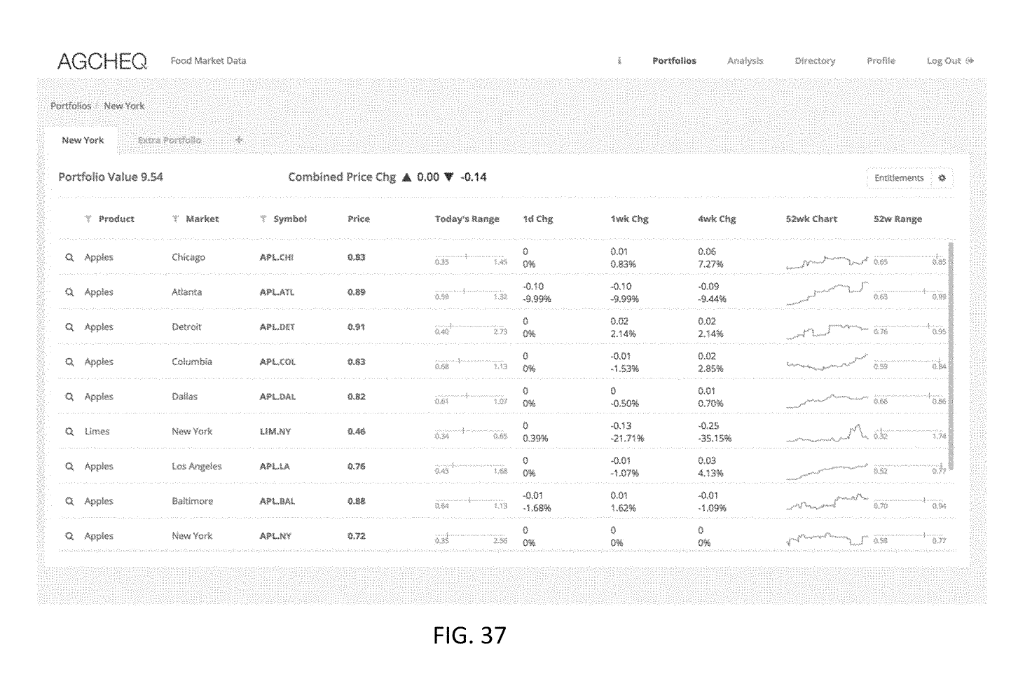

FIG. 37 is a screenshot for a user's portfolio. After signing up and logging in, the user is taken straight to his portfolios that contain current, historical and expected future price information on all products chosen by the user to reflect either crops for sale or items to be purchased.

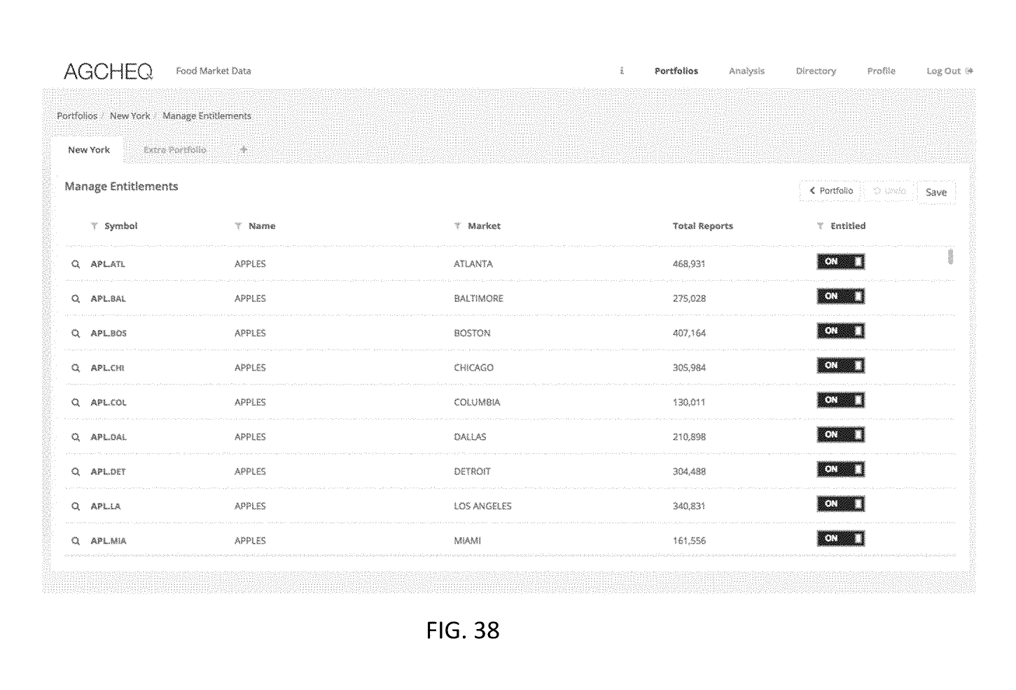

FIG. 38 is a screenshot of modifying portfolio contents. A user can add or remove products, beyond those that the system recognizes such as if the user's menu or crops are publicly available, into any portfolio and thus activate the live and historical data feeds.

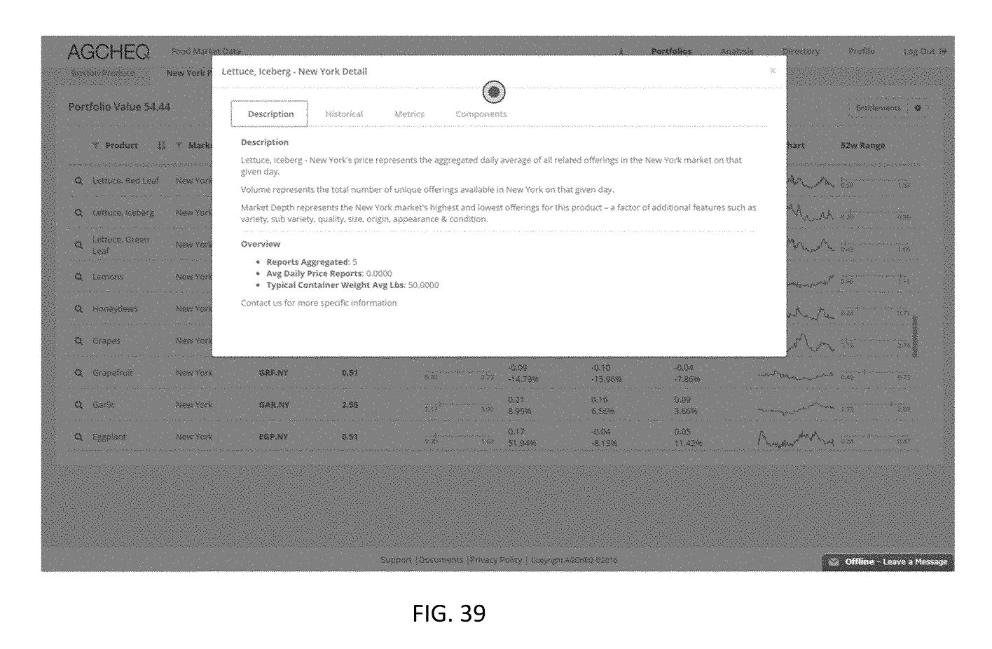

FIG. 39 is a screenshot of the description about iceberg lettuce in New York market in a user's portfolio. The description provides a definition of the underlying product, structure and significance of the product.

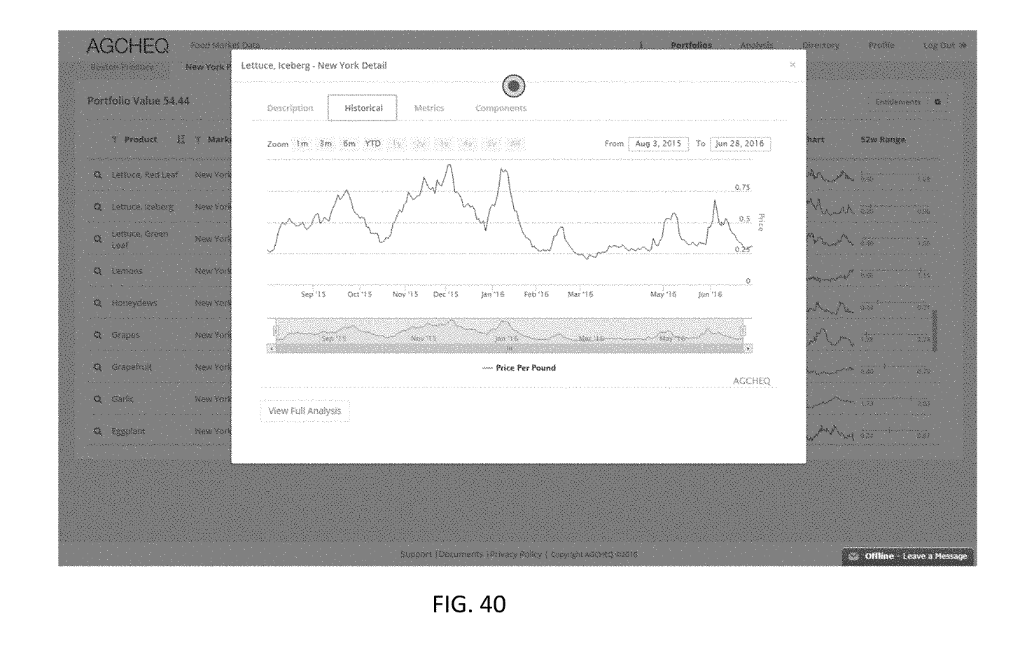

FIG. 40 is a screenshot of historical data about iceberg lettuce in New York market in a user's portfolio. A price history in a certain range is displayed in a chart. In this figure, the chart provides a quick look of the price per pound history between Aug. 3, 2015 and Jun. 28, 2016.

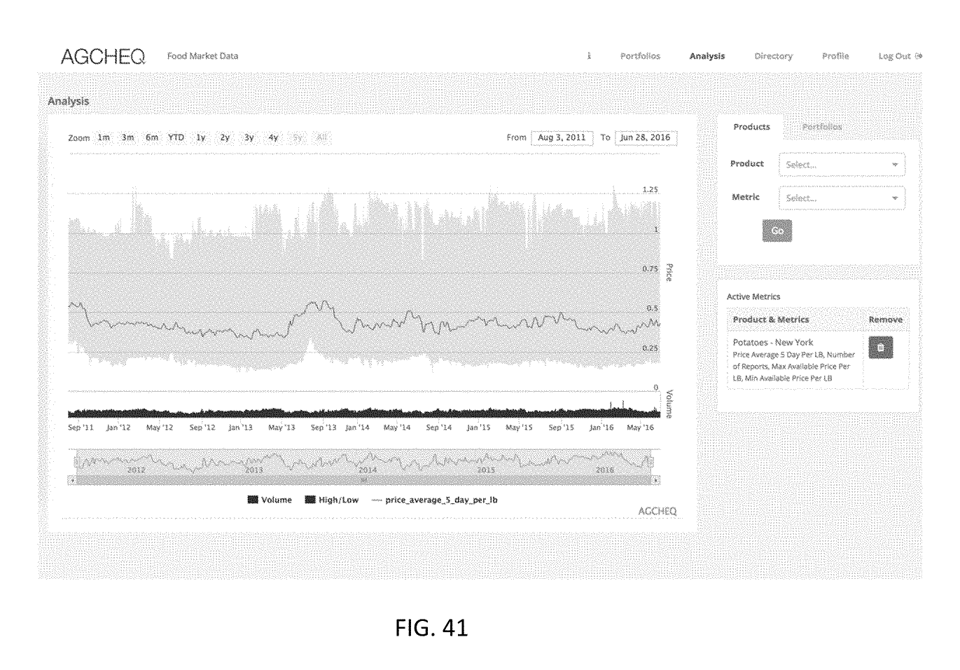

FIG. 41 is a screenshot of a product chart and analysis. The analysis helps users to determine market levels of support or resistance, the best times to buy or sell, relative changes, averages over time.

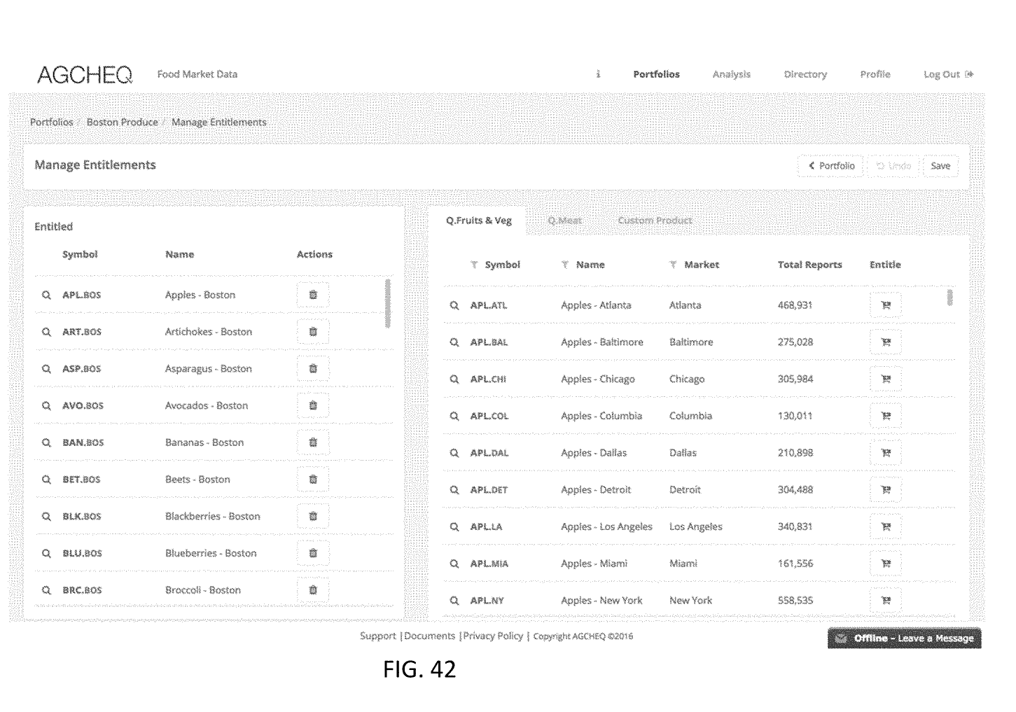

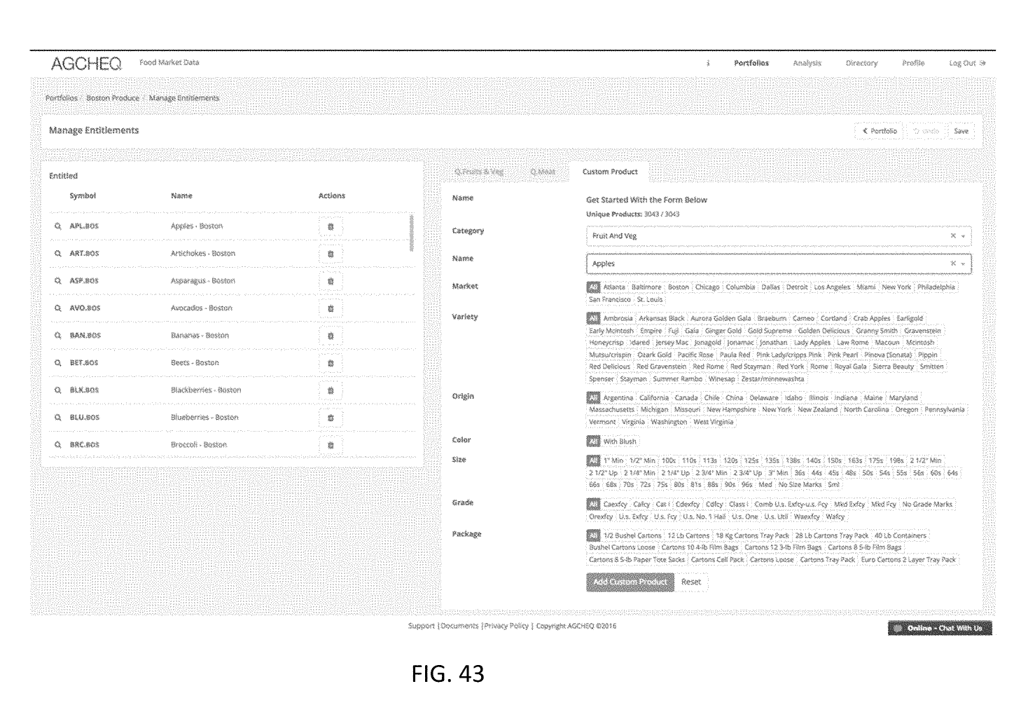

FIG. 42 is a screenshot of entitlements in a user's portfolio. FIG. 43 is a screenshot of managing entitlements for a unique product in a portfolio. This “manage entitlements” function provides the ability to drill down to unique products and importantly allows a user to create any kind of aggregate index of their choosing. The number of possible options is in the millions and offers a degree of unparalleled precision.

The present invention provides systems and methods for generating unique custom perishable foods, specialty crops and proteins price benchmarks in real time for spot and future sales, purchases, negotiations, crop insurance, investments, borrowing and lending.

In one embodiment, the present invention provides a method for assigning package weights to agricultural products where the package weight was not explicitly given. The method includes determining the package weight based on the package name; determining the package weight based on the unit of sale; and determining the package weight using a mapping of the combination of various product values including name, variety, and size to pound weights.

In one embodiment, the present invention proposes a method for aggregating the prices of specific agricultural products together such that a representative price of a more general product can be determined. The method includes automatically filtering the specific products to include in each general product such that the general product price is representative of the market as a whole; excluding prices of included products that would lead to distortions in the general product price; and determining multiple layers of specificity such that prices for aggregate general products of various levels of specificity may be quoted. In another embodiment, the method further comprises aggregating specific prices together such that the aggregated prices are weighted by the traded volume of the at least one product. In yet another embodiment, the method further comprises aggregating the prices of different products together such that a price may be determined for a heterogeneous group of products. In another embodiment, the method further allows for the aggregation and collection of various products and their prices that reflect the real-world portfolio or basket, such as crop harvest, planting schedule, menu item, or total perishable food purchases, so as to generate a single unified price value for accountability, tracking, forecasting, planning and negotiation.

In one embodiment, the present invention provides a method for retrieving, standardizing, and storing third party agricultural market data. The method comprises defining the data sources to import in a standardized format; automatically retrieving the raw data from the defined sources at the specified intervals; storing the raw data electronically for future use; automatically correcting errors and inconsistencies in the source data; automatically identifying invalid data; and automatically deriving standardized values from the source data; storing the standardized data electronically for future use. In another embodiment, the method further comprises, for each revision of the software and each time the software runs, automatically recording sufficient information about the software and execution to be able to uniquely identify how each unit of processed data was produced.

In one embodiment, the present invention provides a system for management and display of agricultural product prices in real time. The system comprises an analytics platform providing internet-based access to various types of clients via private accounts, enabling assembly of agricultural products into portfolios, managing these portfolios, selecting both specific agricultural products as well as aggregated general products of varying levels of specificity for inclusion in these portfolios, viewing derived metrics about these portfolios, detailed descriptions of all products, historical price data for all products, as illustrated in FIGS. 37-39, as an example. In another embodiment, the analytics platform further comprises a quick start component surveying users for their needs in order to automatically create a preconfigured experience. In another embodiment, the analytics platform further includes components customizing the features and tools available to the client based on the type of client such that client from one vertical may have access to different features than clients from a different vertical. In another embodiment, the analytics platform further comprises a component enabling an interface to be rendered with different branding and accessible through different internet addresses. In another embodiment, the system further comprises a mobile component for managing and viewing agricultural market data. In another embodiment, the system further comprises a component enabling the creation and management of user customizable charts of agricultural market data including the ability to cross compare data from various products, timelines, and other data sources, as an example in FIG. 40.

In another embodiment, the system is further operable for uploading Food Service Operations purchasing records; mapping products in the purchasing records to the indexes stored in the system and displaying the actual prices paid and the benchmark price paid on the same page.

In one embodiment, systems and methods in the present invention are built with blockchain technology. Market data from various sources for perishable agricultural products are recorded on a distributed ledger in real time with time stamps. Benchmark prices are calculated based on the market data and location associated with the perishable agricultural products, and are also recorded on the blockchain, thereby providing a retrievable and verifiable and transparent benchmark price of a perishable agricultural product for all market participants. The blockchain technology is based on decentralized internet and inextricably tied to computer-based technology.

The proprietary platform in the present invention collects, sanitizes, analyzes, and summarizes real-time agricultural market data from a variety of sources according to a proprietary algorithm. The proprietary platform further provides interaction between users and their portfolios. These steps in the present invention could not be performed before the internet or computer technology, nor can these steps be performed using only mental processes. Further, based on the steps in the present invention, volume/market weighted average price benchmark indices for perishable food and agricultural products are created to provide insights for farm investments, crop insurance valuations, operation loan and other business decisions. None of those functions and/or features provided by the proprietary platform is not well-understood, routine or conventional.

Case Study 1: Why Ground Beef Prices Matter to McDonald's Stock

Just as iron ore prices matter for steel makers and crude prices matter for refineries, it's important to keep an eye on fresh food prices for all restaurant stocks.

In purchasing more than 1 billion pounds every year, McDonald's (NYSE: MCD) has exposure to the US Beef Market, specifically ground beef. According to the AGCHEQ Ground Beef Indexes after the late 2015 collapse, the Ground Beef Market is rallying.

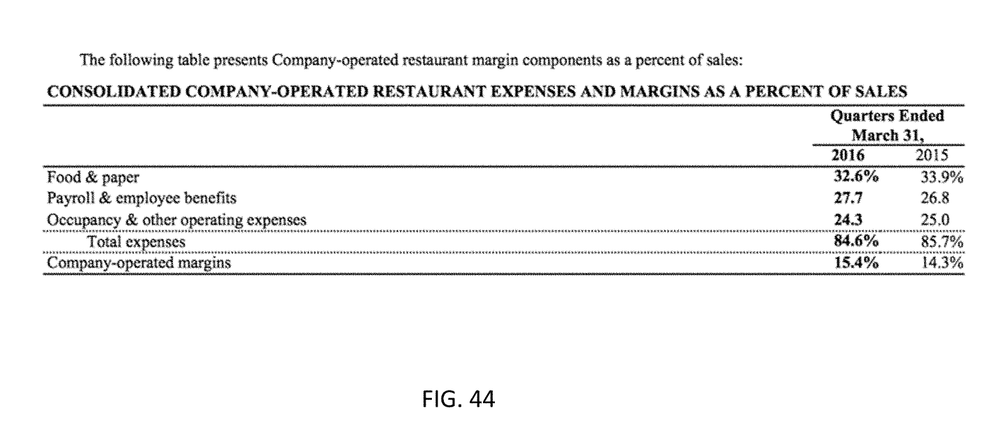

Across the restaurant industry, food costs matter to the bottom line, and food costs contribute the largest percentage of the changes to operating expenses that directly impact gross margins and overall profitability. Even a giant like McDonald's, food costs were 32.6% of all expenses in the 2016 first quarter according to its quarterly report (https://www.sec.gov/Archives/edgar/data/63908/000006390816000121/mcd-331201610q.pdf). Moreover, this spending is highly concentrated as 75% of their grocery bill comes from just 10 different commodities. FIG. 44 is a table representing company-operated restaurant margin components as a percent of sales.

Unfortunately, it is difficult to determine and track what the actual prices are of these highly important top 10 items; in fact, it is not possible to determine and track prices manually in real time or near real time; thus, the present invention is inextricably linked to computer technology and provides an improvement to the technological field of commodity pricing, and more particularly to food pricing. In one example embodiment for a known fast food restaurant, McDonald's restaurants sell “two all-beef patties, special sauce, lettuce, cheese, pickles—on a sesame seed bun”—and known, traded commodities like #2 Soft Red Winter Wheat or Live Feeder Cattle.

Knowing and understanding real food input prices as accurately and precisely as possible in real time or near real time and communicating them visually and/or presenting them in a graphic user interface (GUI) for actionable steps to be taken is imperative to effectively managing investment risk, which is a longstanding, unmet need of this technological field. In this regard, when it comes to perishable foods of various categories, whether Meats, Fruits or Vegetables, the USDA does more than just regulate and protect the food chain. By law, USDA reporters record activity at all major beef producing plants and wholesale produce markets. By aggregating, normalizing and analyzing this USDA metadata, the present invention described herein for the AGCHEQ proprietary platform, systems, and methods has created accurate cost indices that track, analyze, and report the price of all the dozens of important perishable foods real time.

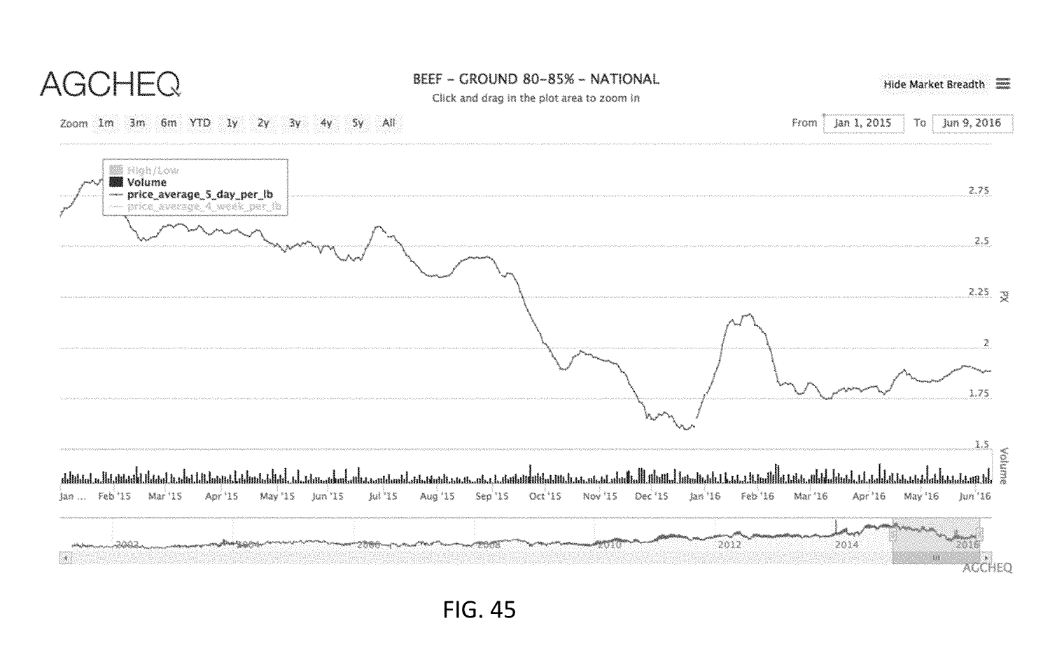

One product that presents the volume weighted average price of the most popular form of ground beef, the AGCHEQ Ground Beef 80-85% Index, shows the importance of having accurate market visibility is to anticipate successful investment returns; this example is illustrated and described in FIGS. 45-48 and their descriptions below.

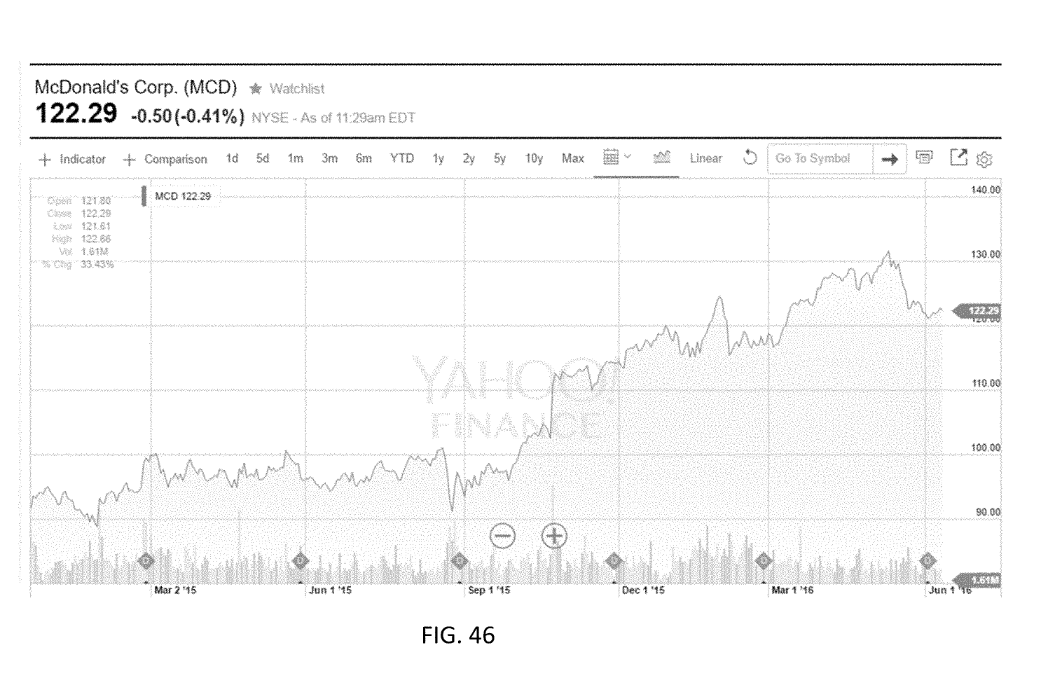

FIG. 45 is a AGCHEQ Ground Beef 80-85% Index's chart since Jan. 1, 2015. FIG. 46 is a MCD stock chart for the same time period (courtesy of Yahoo Finance). These charts demonstrate how the respective moves began in September and are near mirror images of one another. The AGCHEQ Ground Beef 80-85% Index broke down from $2.75 per pound to $1.75 (−36%). Meanwhile, MCD rallied from approximately $95 to briefly over $130.

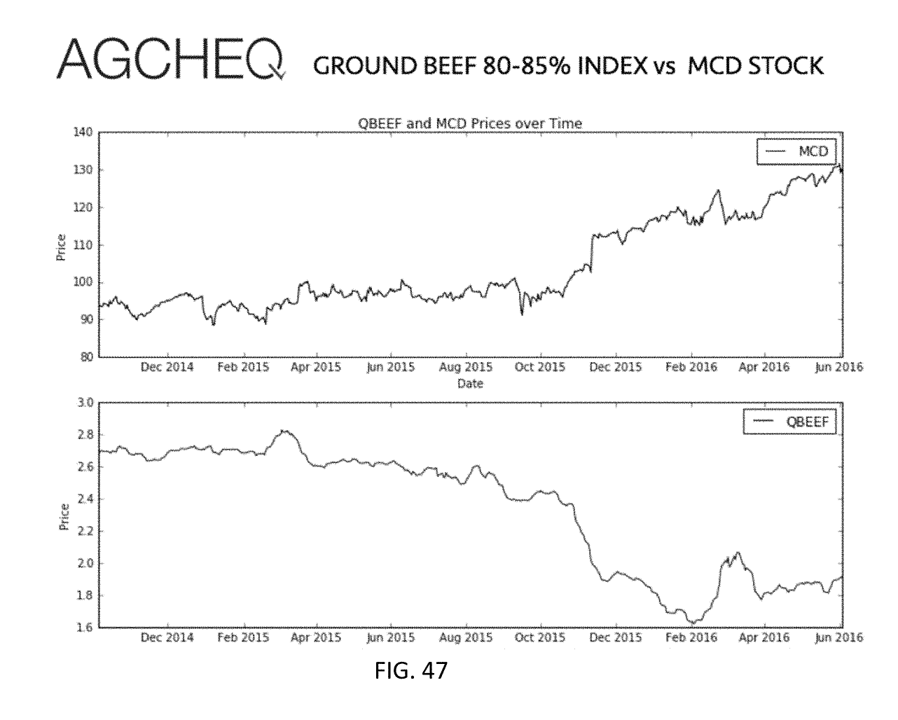

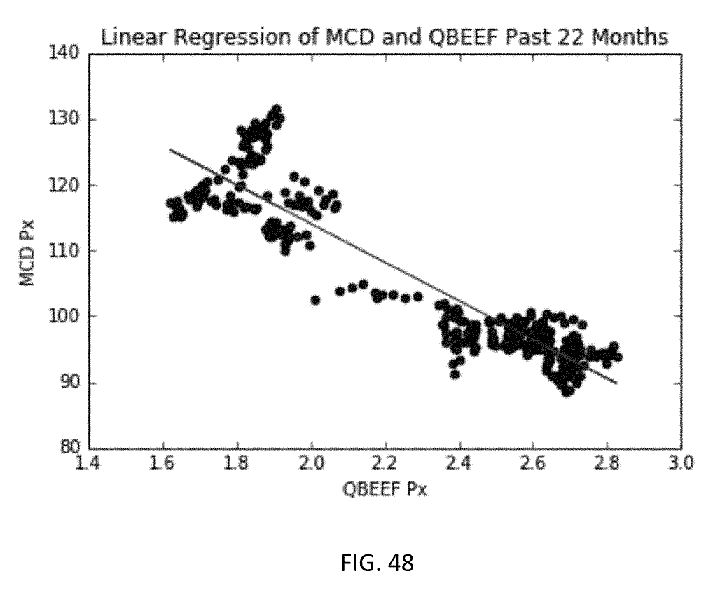

When final goods sale prices are constant, changes negatively correlated input costs, such as ground beef for burgers, go straight to the bottom line. FIG. 47 is a comparison of ground beef 80-85% index and MCD stock over time. Over the last 22 months until June 2016, the AGCHEQ Ground Beef 80-85% Index has had a r-squared correlation of 0.86 to MCD stock performance. FIG. 48 shows a linear regression of MCD stock performance and AGCHEQ Ground Beef 80-85% Index.

Case Study 2: Improving West Coast Food Prices Will Impact Restaurant Earning

Investors have traditionally been unable to precisely quantify the impacts of macro factors, such as the persistent California Drought, on local food prices impacts until after their restaurant stocks publish their 10-Q Quarterly Earnings Release.

Almost half the publicly traded restaurants operate regionally and their food costs represent approximately 30% of expenses. Overall fresh food prices vary dramatically between markets, and it is critical for food costs to track prices as accurately and as locally as possible. This is especially important for the public restaurant groups that operate exclusively in regional markets such as:

Bob Evans (NASDAQ: BOBE)—Eastern & Central

Carrabba's Italian Grill (NASDAQ: BLMN)—Eastern

Chuy's Holdings (NASDAQ: CHUY)—Eastern & Central

Cracker Barrel (NASDAQ: CBRL)—Eastern & Central

Habit Restaurants (NASDAQ: HABT)—Eastern & Western

Jack In The Box (NASDAQ: JACK)—Western & Central

El Pollo Loco (NASDAQ: LOCO)—Western

Noodles & Co (NASDAQ: NDLS)—Western & Eastern

Potbelly (NASDAQ: PBPB)—Eastern & Central

Shake Shack (NYSE: SHAK)—Eastern

Fiesta Restaurant Group (NASDAQ: FRGI)—Southern

Zoe's Kitchen (NYSE: ZOES)—Southern & Eastern

Understanding real-time market prices for every critical item and the historical basis spreads between markets is critical to effectively managing risk and determining where to find relative outperformance.

Investors need to be able to compare the wholesale prices of goods not just in regions but in specific cities such as New York vs. LA, Chicago vs. Dallas, Boston vs. Miami and so forth.

Now, food market data shows that after years of compression, in large part because of drought, prices spreads between Los Angeles and New York are returning. Restaurants operating in the West Coast are regaining their competitive advantage compared with their East Coast competitors.

West Coast menu prices were forced to rise in response to the input price spikes in the 2015 California drought. However, this recent drop in crucial input costs should improve gross margins and fall straight to the bottom line.

Likewise, lower prices for fresh foods at the West Coast grocery stores are also positively impacting the consumer's wallets, enabling greater spending on food away from home category. When it comes to the stocks above, look for relative outperformance in companies that are based in or generally operate in the West Coast such as Jack In The Box, El Pollo Loco and The Habit Restaurants.

As the sheer complexity of the food system prevents most investors having accurate insights into input costs are at such a granular level, it is possible that East Coast firms not benefiting from this price shift will report weaker than expected earnings on a relative basis. This is a specific negative element for companies such as Bob Evans Farms, Bloomin' Brands, Chuy's Holdings, Cracker Barrel Old Country Store, Potbelly Corp., Shake Shack and Zoe's Kitchen that creates the risk of underperformance.

Thus, AGCHEQ's specialized food market data services can add value by offering accurate visibility into the food costs of every restaurant group.

AGCHEQ Meat, Poultry, Fruit and Vegetable Indices aggregate market data from 27 major markets into indexes on the leading 60 major commodities (composed of 4700,000+ unique fresh food products). Daily wholesale market updates offer precise transparency into price changes and trends of the most important inputs. When doing so, accurate volume weighted average price indexes is far and away the most accurate method of gauging food prices in a market that has more 4,000 unique package variations and a further 100 times more unique products.

The proprietary platform, systems and methods of the present invention are operable to quantify individual food cost shifts Comparing select AGCHEQ Vegetable Price Indexes between Los Angeles and New York over the last 5 years shows the huge, volatile price spreads and demonstrates the importance of accurate food cost visibility on a local level.

Most importantly for investors, these indexes show in real time precisely how wholesale prices spreads on a number of important items are improving again. Prices in Los Angeles were rising faster than prices in New York for several years are improving once again, the competitive advantage is returning.

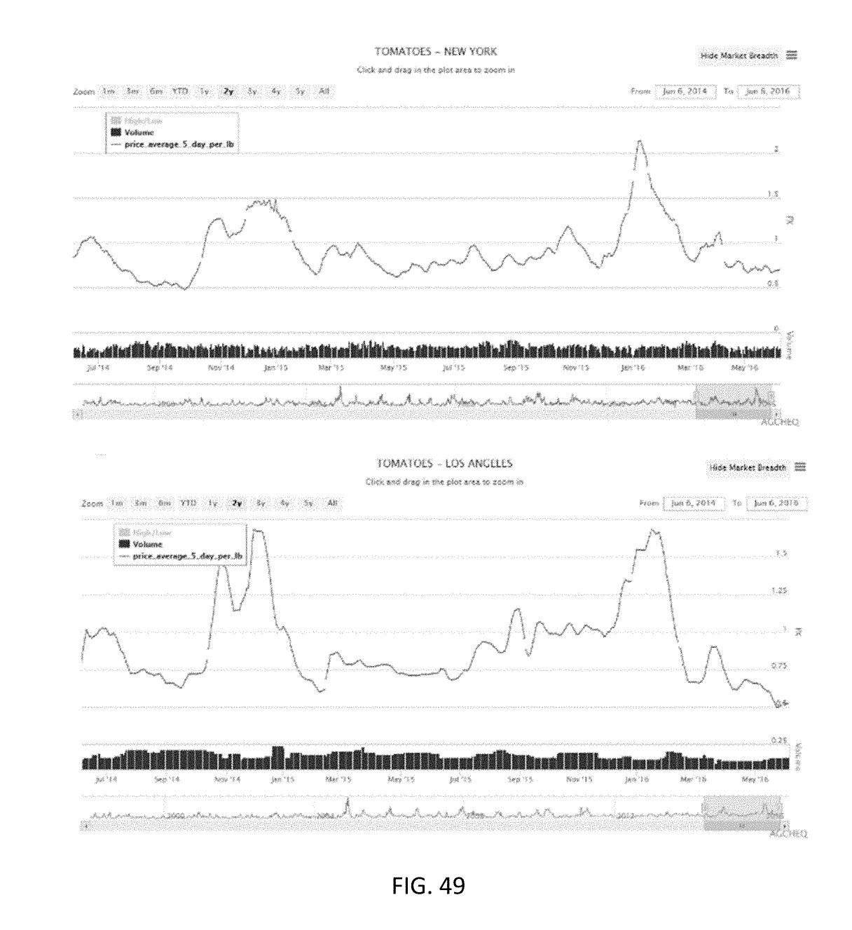

FIG. 49 is a comparison of AGCHEQ Tomato New York Index and AGCHEQ Tomato Los Angeles Index. AGCHEQ Tomato New York Index (TOM.NY) traded 11.7% higher than AGCHEQ Tomato Los Angeles Index (TOM.LA) over the last 5 years. This spread went down to just 0.4% over the last 2 years (below) but has since returned to +21.1% over the last 3 months until June 2016.

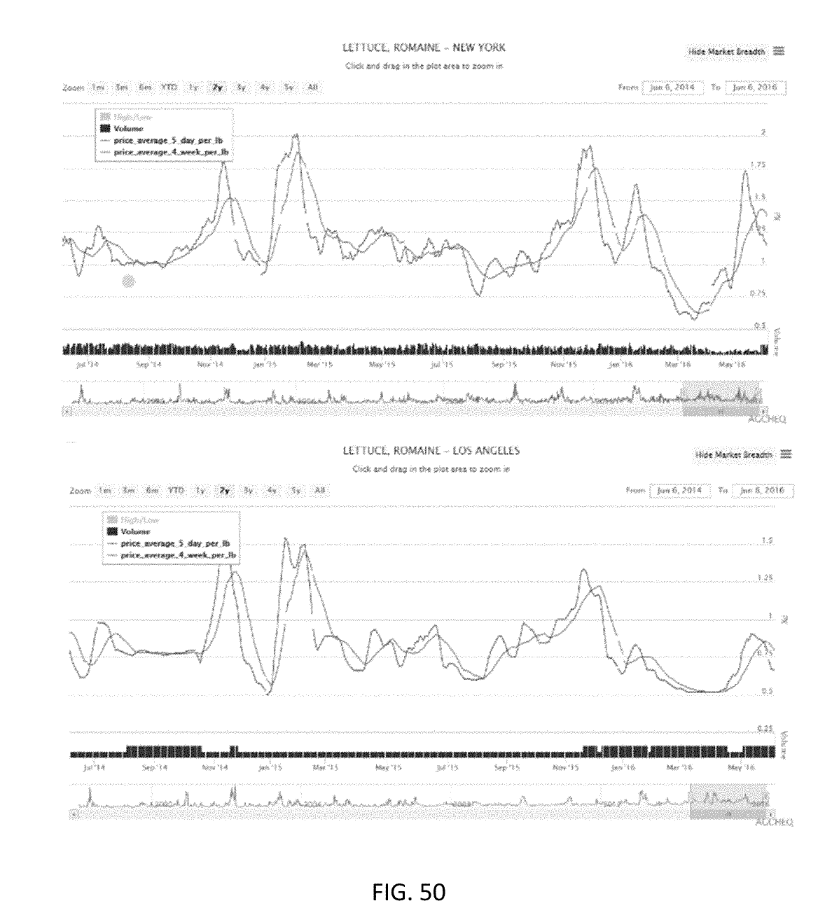

FIG. 50 is a comparison of AGCHEQ Romaine Lettuce New York Index and AGCHEQ Romaine Lettuce Los Angeles Index. AGCHEQ Romaine Lettuce New York Index (LTR.NY) traded 49.1% higher than AGCHEQ Romaine Lettuce Los Angeles (LTR.LA) for five years. This spread dropped to 39.9% over the last 2 years (below) but has shot back to 57.2% in the last 3 months until June 2016.

At its peak, the prices of Avocados where even higher in L.A. than in New York—now they are back to being 20.9% cheaper. The return of this historic price spread is occurring across the spectrum and is even more dramatic in the important Fruit markets. Given non-perishable food prices remain very stable across markets (not much arbitrage opportunity for Ketchup or Bread), fresh food prices like produce impact company costs far more than expected.

These examples underscore the double-digit price spreads between markets determined by the unique characteristics of every individual fresh commodity.

With solutions provided by the present invention including the AGCHEQ Indexes, the impact of macro factors is quantified in real time for use in investment analytics for any scenario, such as the California drought in real-time. For chains based in the West Coast, this recently lost competitive advantage is returning and now it is possible to precisely measure, before earnings, just how quickly that is happening.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A system for creating volume/market weighted average price benchmark indexes for perishable agricultural products, comprising:
at least one user device constructed and configured in network-based communication with an analytics platform;
wherein the analytics platform is operable to collect, analyze, validate and normalize data elements for perishable agricultural products in real time, thereby generating processed data;
wherein the analytics platform is operable to calculate a benchmark price for a perishable agricultural product weighted by traded volumes based on the processed data and location data associated with the perishable agricultural product; and
wherein the at least one user device is operable to receive and display the benchmark price.

2. The system of claim 1, wherein the data elements comprise price reports, movement reports, production reports, and crop insurance reports, and wherein the data elements are United States Department of Agriculture (USDA) verified.

3. The system of claim 1, wherein the analytics platform is further operable to automatically retrieve the data elements from defined sources at specified intervals.

4. The system of claim 1, wherein the analytics platform is further operable to automatically correct errors and inconsistencies in the data elements and automatically identify invalid data.

5. The system of claim 1, wherein the analytics platform is further operable to create an aggregate product by averaging the data elements for perishable agricultural products of same characteristics.

6. The system of claim 5, wherein the analytics platform is further operable to aggregate multiple types of perishable agricultural products into indexes to provide insight into a particular region, industry, company or another facet.

7. The system of claim 6, wherein the analytics platform is further operable to combine the indexes into other indexes or into user portfolios.

8. The system of claim 1, wherein the data elements are recorded on a distributed ledger with time stamps.

9. The system of claim 1, wherein the benchmark price is in a normalized form of dollar per pound.

10. The system of claim 1, wherein the analytics platform is further operable to forecast a commodity price based on historical prices stored on the analytics platform.

11. The system of claim 10, wherein the forecasting is performed with one of the following algorithms: Artificial neural Network, Hidden Markov Model, and Support Vector Machine.

12. The system of claim 1, wherein the analytics platform is further operable to assign a package weight to a perishable agricultural product by mapping a combination of product values including name, variety, and size to pound weights.

13. The system of claim 1, wherein the analytics platform is further operable to aggregate prices of different products in a user portfolio and generate a single unified price value for accountability, tracking, forecasting, planning and negotiation.

14. The system of claim 1, wherein the at least one user device comprises an application program associated with the analytics platform providing access via private accounts.

15. The system of claim 1, wherein the at least one user device is operable to display the processed data in charts, tables and/or graphs.

16. A method for creating volume/market weighted average price benchmark indexes for perishable agricultural products, comprising:
providing at least one user device constructed and configured in network-based communication with an analytics platform;
the analytics platform collecting, analyzing, validating and normalizing data elements for perishable agricultural products in real time, thereby generating processed data;
the analytics platform calculating a benchmark price for a perishable agricultural product weighted by traded volumes based on the processed data and the location data associated with the perishable agricultural product; and
the at least one user device receiving and displaying the benchmark price.

17. The method of claim 16, wherein the at least one user device comprises an application program providing access to the analytics platform via a private account.

18. The method of claim 17, further comprising the analytics platform geolocating the private account to nearest specific wholesale markets based on information associated with the private account comprising Business Name, Address, Menu Items and/or Crops Harvested.

19. The method of claim 17, further comprising the analytics platform providing customized data for the private account by collecting and aggregating all available market data associated with the private account.

20. The method of claim 17, further comprising the analytics platform forecasting and presenting statistically likely price ranges to the private account for preparing budgets, negotiating forwards and futures contracts, and/or obtaining operating capital loans or risk management products.
